(19) United States
(12) Patent Application Publication
(10) Pub. No.: US 2015/0311564 A1
(43) Pub. Date: Oct. 29, 2015

(54) ELECTROLYTIC SOLUTION FOR NON-AQUEOUS SECONDARY CELL, NON-AQUEOUS SECONDARY CELL, AND ADDITIVE FOR ELECTROLYTIC SOLUTION

(71) Applicant: FUJIFILM Corporation, Tokyo (JP)

(72) Inventor: Yohei ISHIJI, Kanagawa (JP)

(73) Assignee: FUJIFILM Corporation, Tokyo (JP)

(21) Appl. No.: 14/791,884

(22) Filed: Jul. 6, 2015

Related U.S. Application Data
(63) Continuation of application No. PCT/JP2014/052298, filed on Jan. 31, 2014.

(30) Foreign Application Priority Data
Feb. 5, 2013 (JP) 2013-020488

(51) Int. Cl. H01M 10/0567; H01M 4/131; H01M 4/136; H01M 4/58; H01M 4/505; H01M 4/525; H01M 4/56; H01M 10/0525; H01M 4/485

(52) U.S. Cl. CPC H01M 10/0567; H01M 10/0525; H01M 4/131; H01M 4/136; H01M 4/485; H01M 4/505; H01M 4/525; H01M 4/56; H01M 4/5825; H01M 2300/0025; H01M 2004/028

(57) ABSTRACT

The present invention provides an electrolytic solution for a non-aqueous secondary cell and an additive for an electrolytic solution. The electrolytic solution includes, in an organic solvent: an electrolyte; and an organic boron compound having at least one nitrogen-boron bond or an organic aluminum compound having at least one nitrogen-aluminum bond. The additive includes an organic boron compound having at least one nitrogen-boron bond or an organic aluminum compound having at least one nitrogen-aluminum bond.

### CROSS-REFERENCE TO RELATED APPLICATIONS

This application is a Continuation of PCT International Application No. PCT/JP2014/052298 filed on Jan. 31, 2014, which claims priority under 35 U.S.C §119(a) to Japanese Patent Application No. JP2013-020488 filed on Feb. 5, 2013. Each of the above application(s) is hereby expressly incorporated by reference, in its entirety, into the present application.

### BACKGROUND OF THE INVENTION

1. Field of the Invention

The present invention relates to an electrolytic solution for a non-aqueous secondary cell, a non-aqueous secondary cell, and an additive for an electrolytic solution.

2. Description of the Related Art

A secondary cell called a lithium ion cell which has recently attracted attention is roughly classified into: a secondary cell (lithium ion secondary cell) in which the storage and release of lithium is used in a charging-discharging reaction; and a secondary cell (lithium metal secondary cell) in which the deposition and dissolution of lithium is used in a charging-discharging reaction. These cells can realize charging and discharging with higher energy density as compared to a lead cell and a nickel-cadmium cell. Using these characteristics, recently, the cells have been widely used in a portable electronic apparatus such as a camera-integrated type VTR (video tape recorder), a mobile phone, or a laptop computer. Along with the expansion in application, the development of a light-weight secondary cell capable of obtaining high energy density as a power source for a portable electronic apparatus has been progressed. Further, recently, a reduction in size and an increase in life and safety are strongly required.

However, a lithium ion secondary cell and a lithium metal secondary cell (hereinafter, these cells will also be collectively referred to simply as “lithium secondary cell”) have a problem of overcharge which is an intrinsic problem thereof in the related art. Regarding this problem, when a secondary cell is continuously charged even after being fully charged, a defect caused by short-circuiting of an electrode may occur. In particular, this problem is intrinsic to a lithium secondary cell using an organic electrolytic solution, and an appropriate countermeasure against the problem is desired from the viewpoint of ensuring safety during use.

To that end, typically, a countermeasure is taken on an electronic apparatus side on which a cell is mounted. For example, a charging circuit is embedded into the electronic apparatus side such that the supply of electricity is interrupted when the cell is fully charged. However, although it is extremely rare, a case is assumed in which the cell may be overcharged due to a defect and the like generated in the above-described circuit. At this time, if a non-aqueous electrolytic solution can be improved to suppress overcharge, the reliability can be further improved.

Some additives are proposed which are added to a non-aqueous electrolytic solution to suppress or prevent the occurrence of overcharge. Representative examples of the additives include biphenyl disclosed in JP1995-302614A (JP-H07-302614A). In addition, JP2001-15158A and JP2002-50398A disclose attempts to ensure reliability during charging by adding an amine compound.

### SUMMARY OF THE INVENTION

As performance required of an overcharge inhibitor, typically, it is required for the overcharge inhibitor to rapidly exhibit its effect only during overcharge without hindering the operation at a normal charging potential. Biphenyl or the like which is an overcharge inhibitor of the related art causes a slight reaction not only during overcharge but also during normal charging. Therefore, when charging and discharging are repeated, the resistance increases, and the capacity decreases. On the other hand, recently, a lithium secondary cell has been diversified in application, and the performance thereof has also been significantly improved. As a result, the structure, member, and operating conditions of a cell largely vary. For example, the performance of a positive electrode varies. In JP-H07-302614A, LiCoO₂ (electrode potential: 4.1 V) is adopted as an active material of a positive electrode. On the other hand, for example, a LiNiMnO-based positive electrode active material is developed, and the electrode potential reaches 4.25 V or higher by using this active material. The present inventors verified that, when biphenyl and the like disclosed in JP-H07-302614A are used under the use conditions of a positive electrode with an increased potential, sufficient ability to prevent overcharge and ability to suppress deterioration in cell performance during normal use cannot be simultaneously ensured (refer to comparative examples described below).

Therefore, an object of the present invention is to provide a non-aqueous secondary cell; and an electrolytic solution for a non-aqueous secondary cell used for the non-aqueous secondary cell, in which high overcharge preventing ability and ability of suppressing deterioration in cell performance can be simultaneously realized.

The above-described problems are solved by the following means.

[1] An electrolytic solution for a non-aqueous secondary cell, including, in an organic solvent:

an electrolyte; and

an organic boron compound having at least one nitrogen-boron bond or an organic aluminum compound having at least one nitrogen-aluminum bond.

[2] The electrolytic solution for a non-aqueous secondary cell according to [1],

in which the organic boron compound or the organic aluminum compound contains a hetero ring having plural heteroatoms selected from nitrogen, oxygen, sulfur, and phosphorus.

[3] The electrolytic solution for a non-aqueous secondary cell according to [1] or [2],

in which the organic boron compound or the organic aluminum compound contains a hetero ring having plural nitrogen atoms.

[4] The electrolytic solution for a non-aqueous secondary cell according to any one of [1] to [3],

in which the organic boron compound or the organic aluminum compound contains a hetero ring having a nitrogen-nitrogen bond.

[5] The electrolytic solution for a non-aqueous secondary cell according to any one of [1] to [4],

in which the organic boron compound or the organic aluminum compound contains a 5-membered hetero ring.

[6] The electrolytic solution for a non-aqueous secondary cell according to any one of [1] to [5],

in which the organic boron compound or the organic aluminum compound contains a hetero ring having pyrazole or triazole in a structure thereof.

[7] The electrolytic solution for a non-aqueous secondary cell according to any one of [1] to [6],

in which the organic boron compound or the organic aluminum compound contains a structural unit represented by the following formula (1),

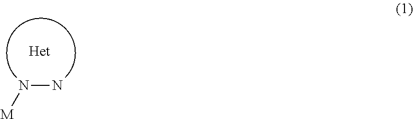

where M represents a boron atom or an aluminum atom; and Het represents a 5-membered or 6-membered hetero ring having a N—N bond.

[8] The electrolytic solution for a non-aqueous secondary cell according to [7],

in which a compound having the structural unit represented by the formula (1) is a compound represented by the following formula (I) or (II),

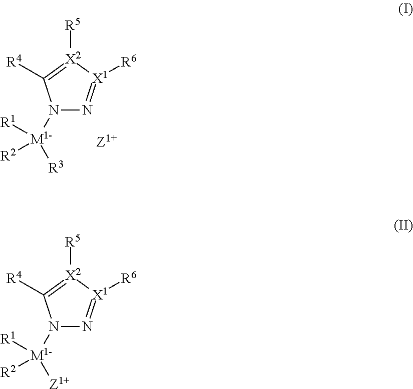

where R¹ to R³ each independently represents a halogen atom, an amino group, a silyl group, an alkoxy group, an aryloxy group, an acyloxy group, a heteroaryloxy group, a sulfonyloxy group-containing group, an alkyl group, an aryl group, or a heteroaryl group; R¹ to R³ may be bonded or condensed to each other to form a ring structure; R⁴ to R⁶ each independently represents a hydrogen atom, an alkyl group, an alkoxy group, a halogen atom, an acyloxy group, an alkoxycarbonyl group, a cyano group, an amino group, a silyl group, an aryl group, or a heteroaryl group; R⁴ to R⁶ may be respectively bonded or condensed to each other to form a ring structure; R¹ to R⁶ may be bonded to N or C on a ring to form a ring structure, in which an inorganic element may be interposed therebetween to form a ring, and a double bond on the ring may be a single bond; M¹ represents a boron atom or an aluminum atom; Z¹⁺ represents an inorganic or organic cation; X¹ and X² each independently represents a carbon atom or a nitrogen atom; and when X¹ and X² represent a nitrogen atom, R⁵ and R⁶ are not present.

[9] The electrolytic solution for a non-aqueous secondary cell according to [8],

in which the formula (II) is represented by the following formula (III) or (IV),

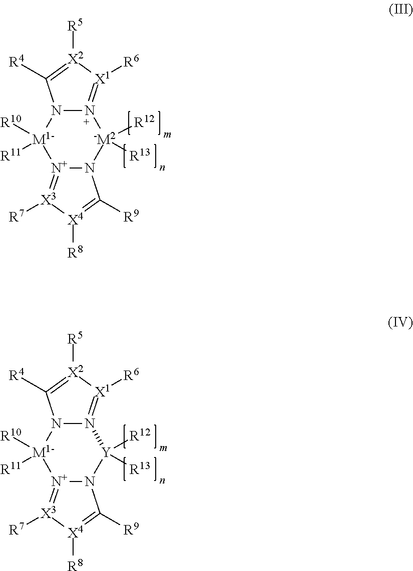

where R¹⁰ to R¹³ each independently represents a halogen atom, an alkoxy group, an aryloxy group, an acyloxy group, a heteroaryloxy group, a sulfonyloxy group-containing group, an alkyl group, an aryl group, or a heteroaryl group and may be respectively bonded or condensed to each other to form a ring structure; when R¹⁰ to R¹³ form a ring, an inorganic element may be interposed therebetween to form a ring; m and n represent an integer satisfying 0≦m+n≦3; R⁴ to R⁶ have the same definitions as in the formula (II); R⁷ to R⁹ have the same definitions as R⁴ to R⁶ in the formula (II); M¹ and M² represent a boron atom or an aluminum atom; Y represents a metal atom other than a boron atom and an aluminum atom; and X¹ to X⁴ each independently represents a carbon atom or a nitrogen atom, in which when X¹ to X⁴ represent a nitrogen atom, R⁵ to R⁸ are not present.

[10] The electrolytic solution for a non-aqueous secondary cell according to [9],

in which the formula (III) is represented by the following formula (V) or (VI),

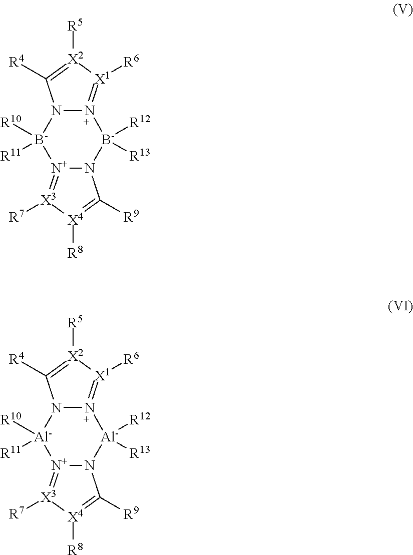

where R⁴ to R¹³ and X¹ to X¹ have the same definitions as in the formula (III).

[11] The electrolytic solution for a non-aqueous secondary cell according to any one of [1] to [10], further comprising:

at least one compound selected from an aromatic compound, a nitrile compound, a halogen-containing compound, an imide compound, a phosphorus-containing compound, a sulfur-containing compound, a silicon-containing compound, a transition metal complex, a rare earth metal complex, and a polymerizable compound.

[12] The electrolytic solution for a non-aqueous secondary cell according to any one of [1] to [11],

in which the content of the organic boron compound or the organic aluminum compound is 0.001 mass % to 10 mass %.

[13] A non-aqueous secondary cell including:

a positive electrode;

a negative electrode; and

the electrolytic solution for a non-aqueous secondary cell according to any one of [1] to [12].

[14] The non-aqueous secondary cell according to [13],

in which the positive electrode contains an active material, the active material is a transition metal oxide capable of storing and releasing alkali metal ions.

[15] The non-aqueous secondary cell according to [13] or [14],

in which the active material contained in the positive electrode contains a transition metal oxide represented by any one of the following formulae (MA) to (MC):

LiₐM¹O_{b} (MA);

Li_{c}M²₂O_{d} (MB); and

LiₑM³(PO₄)_{f} (MC),

where M¹ and M² each independently represents one or more elements selected from Co, Ni, Fe, Mn, Cu, and V; M³ represents one or more elements selected from V, Ti, Cr, Mn, Fe, Co, Ni, and Cu; a portion of M¹ to M³ may be substituted with at least one selected from elements other than lithium in Group 1 (Ia) of the periodic table, elements in Group 2 (IIa) of the periodic table, Al, Ga, In, Ge, Sn, Pb, Sb, Bi, Si, P, and B; a represents 0 to 1.2; b represents 1 to 3; c represents 0 to 2; d represents 3 to 5; e represents 0 to 2; and f represents 1 to 5.

[16] The non-aqueous secondary cell according to any one of [13] to [15],

in which an active material of the positive electrode is lithium cobalt oxide, lithium manganese oxide, lithium nickel oxide, lithium nickel manganese cobalt oxide, lithium manganese nickel oxide, lithium nickel cobalt aluminum oxide, or lithium iron phosphate.

[17] The non-aqueous secondary cell according to any one of [13] to [16],

in which the negative electrode contains an active material, lithium titanium oxide (LTO) or a (composite) carbon material is used as the active material of the negative electrode.

[18] The non-aqueous secondary cell according to any one of [13] to [17],

in which a normal charging positive electrode potential of the cell is 4.25 V or higher (vs. Li/Li^{|}).

[19] The non-aqueous secondary cell according to any one of [13] to [18],

in which a resistance increase rate is 5 or more which is calculated by impedance measurement according to the following expression:

Resistance Increase Rate=(Resistance after Charging to Positive Electrode Potential of 5 V)/(Resistance after Charging to Positive Electrode Potential of 4.1 V)

[20] An additive for an electrolytic solution including:

an organic boron compound having at least one nitrogen-boron bond or an organic aluminum compound having at least one nitrogen-aluminum bond.

[21] The additive for an electrolytic solution according to [20],

in which the organic boron compound or the organic aluminum compound is represented by the following formula (I) or (II),

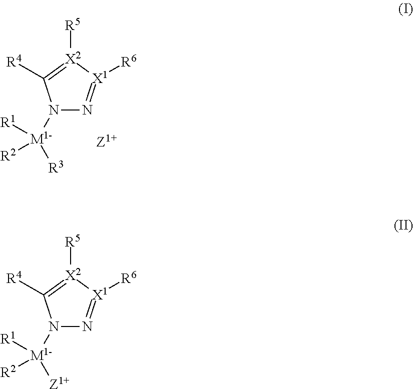

where R¹ to R³ each independently represents a halogen atom, an amino group, a silyl group, an alkoxy group, an aryloxy group, an acyloxy group, a heteroaryloxy group, a sulfonyloxy group-containing group, an alkyl group, an aryl group, or a heteroaryl group; R¹ to R³ may be respectively bonded or condensed to each other to form a ring structure; R⁴ to R⁶ each independently represents a hydrogen atom, an alkyl group, an alkoxy group, a halogen atom, an acyloxy group, an alkoxycarbonyl group, a cyano group, an amino group, a silyl group, an aryl group, or a heteroaryl group; R⁴ to R⁶ may be respectively bonded or condensed to each other to form a ring structure; R¹ to R⁶ may be bonded to N or C on a ring to form a ring structure, in which an inorganic element may be interposed therebetween to form a ring, and a double bond on the ring may be a single bond; M¹ represents a boron atom or an aluminum atom; Z¹⁺ represents an inorganic or organic cation; X¹ and X² each independently represents a carbon atom or a nitrogen atom; and when X¹ and X² represent a nitrogen atom, R⁵ and R⁶ are not present.

With the electrolytic solution for a non-aqueous secondary cell and the non-aqueous secondary cell according to the present invention, high overcharge preventing ability and ability to suppress deterioration in cell performance can be realized. In addition, even under conditions where a high-potential positive electrode is optionally used, high performance thereof can be exhibited.

The above-described and other characteristics and advantageous effects of the present invention will be clarified from the following description and the accompanying drawings.

### BRIEF DESCRIPTION OF THE DRAWINGS

FIG. 1 is a cross-sectional view schematically showing a mechanism of a lithium secondary cell according to a preferred embodiment of the present invention.

FIG. 2 is a cross-sectional view showing a specific configuration of the lithium secondary cell according to the preferred embodiment of the present invention.

### DESCRIPTION OF THE PREFERRED EMBODIMENTS

An electrolytic solution for a non-aqueous secondary cell according to the present invention contains an electrolyte and the following specific organic boron compound or organic aluminum compound in an organic solvent. Hereinafter, the present invention will be described in detail centering on the specific organic boron compound or organic aluminum compound.

<Specific Organic Boron Compound or Organic Aluminum Compound>

The specific organic boron compound or organic aluminum compound used in the present invention has at least one nitrogen-boron bond or a nitrogen-aluminum bond, respectively. It is preferable that the organic boron compound or the organic aluminum compound contains a hetero ring having plural heteroatoms selected from nitrogen, oxygen, sulfur, and phosphorus. It is preferable that the organic boron compound or the organic aluminum compound contains (i) a hetero ring having plural nitrogen atoms, (ii) a hetero ring having a nitrogen-nitrogen bond, or (iii) a 5-membered hetero ring. Among these, a hetero ring having a pyrazole structure or a triazole structure as a partial structure is preferable.

Here, examples of the hetero ring are shown below.

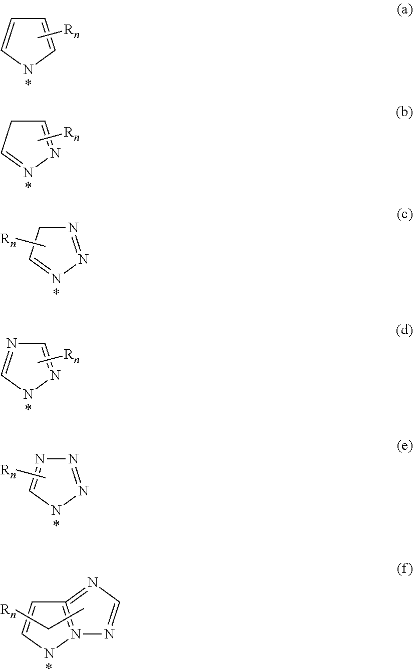

* represents a binding site with a boron atom or an aluminum atom. R represents a substituent, and preferable examples thereof are the same as those of R⁴ to R⁶. n represents an integer which is the number of substitutable sites or less, for example, 4 or less in (a), 3 or less in (b), and 2 or less in (c).

It is preferable that the organic boron compound or the organic aluminum compound contains a structural unit represented by the following formula (1).

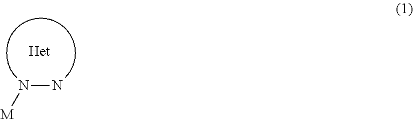

In the formula, M represents a boron atom or an aluminum atom. Het represents a 5-membered or 6-membered hetero ring adjacent to a N—N bond. The preferable range of the hetero ring is the same as described above. The hetero ring and M may further contain a substituent. It is preferable that the substituent in the hetero ring has the same definition as R. It is preferable that the substituent in M has the same definition as R¹ to R³. Plural substituents may be present. In this case, the substituents may be bonded or condensed to each other to form a ring. In addition, M may be bonded to N or C on the Het ring. The N—N bond on the Het ring may be a single bond or a double bond.

It is more preferable the organic boron compound or the organic aluminum compound is a compound represented by the following formula (I) or (II).

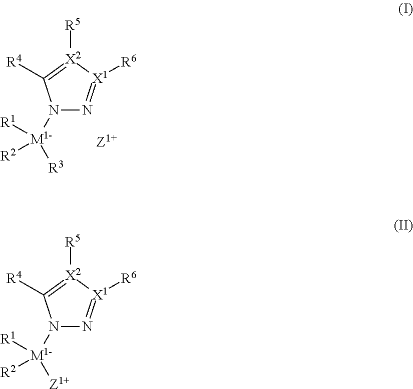

•R¹ to R³

In the formula, R¹ to R³ each independently represents a halogen atom, an amino group (preferably having 0 to 6 carbon atoms and more preferably having 0 to 3 carbon atoms), a silyl group (preferably having 1 to 12 carbon atoms and more preferably having 1 to 6 carbon atoms), an alkoxy group (preferably having 1 to 12 carbon atoms and more preferably having 1 to 6 carbon atoms), an aryloxy group (preferably having 6 to 22 carbon atoms and more preferably having 6 to 14 carbon atoms), an acyloxy group (preferably having 1 to 12 carbon atoms and more preferably having 1 to 6 carbon atoms), a heteroaryloxy group (preferably having 1 to 12 carbon atoms and more preferably having 2 to 5 carbon atoms), a sulfonyl group-containing group (R—SO₂—: R represents an alkyl group having 1 to 6 carbon atoms, an aryl group having 6 to 10 carbon atoms, an alkoxy group having 1 to 6 carbon atoms, or an acyl group having 1 to 6 carbon atoms), an alkyl group (preferably having 1 to 12 carbon atoms and more preferably having 1 to 6 carbon atoms), an aryl group (preferably having 6 to 22 carbon atoms and more preferably having 6 to 14 carbon atoms), or a heteroaryl group (preferably having 1 to 12 carbon atoms and more preferably having 2 to 5 carbon atoms). As the heteroaryl group in the heteroaryloxy group and the heteroaryl group, a 5-membered or 6-membered ring is preferable, and specific examples thereof include a pyridyl group, a pyrazyl group, a pyrimidyl group, a pyridazyl group, a pyrazolyl group, an imidazolyl group, a triazolyl group, and a tetrazolyl group (hereinafter, this preferable heteroaryl group will be referred to as “Ha”).

In this specification, the meaning of the acyl group includes an aryloyl group.

•R⁴ to R⁶

R⁴ to R⁶ each independently represents a hydrogen atom, an alkyl group (preferably having 1 to 12 carbon atoms and more preferably having 1 to 6 carbon atoms), an alkoxy group (preferably having 1 to 12 carbon atoms and more preferably having 1 to 6 carbon atoms), a halogen atom, an acyloxy group (preferably having 1 to 12 carbon atoms and more preferably having 1 to 6 carbon atoms), an alkoxycarbonyl group (preferably having 2 to 12 carbon atoms and more preferably having 2 to 6 carbon atoms), a cyano group, an amino group (preferably having 0 to 6 carbon atoms and more preferably having 0 to 3 carbon atoms), a silyl group (preferably having 1 to 12 carbon atoms and more preferably having 1 to 6 carbon atoms), an aryl group (preferably having 6 to 22 carbon atoms and more preferably having 6 to 14 carbon atoms), or a heteroaryl group (preferably having 1 to 12 carbon atoms and more preferably having 2 to 5 carbon atoms). R⁴ to R⁶ may be bonded or condensed to each other to form a ring structure. As the heteroaryl group in the heteroaryloxy group and the heteroaryl group, the above-described examples of the heteroaryl group Ha are preferable.

In addition, R¹ to R⁶ may be bonded to N or C on a ring to form a ring structure. At this time, a double bond on the ring may be a single bond. In addition, an inorganic element Ya (preferably Sn, Zr, Zn, Cu, Mg, Mn, Ni, or Co) is interposed between the elements to form a ring. This inorganic element Ya may have a substituent or a ligand, and examples thereof are the same as the examples of R¹ to R³. It is preferable that a nitrogen atom contributing this bond is N in the second site (in the formulae (I) and (II), N between N and X¹). It is preferable that a group forming a ring is R³ or Z¹. It is preferable that, when R⁴ to R⁶ is bonded to N or C on a ring, the structure of a compound is represented by the following formula (Ia) or (IIa).

•M¹

M¹ represents a boron atom or an aluminum atom.

•Z¹⁺

Z¹⁺ represents an inorganic or organic cation. Preferable examples of Z¹⁺ include an onium salt or an ammonium salt of an organic hetero ring such as pyrazole, imidazole, pyridine, thiazole, or triazole; and an inorganic cation (Na⁺, K⁺, or Li⁺). The M¹⁻-Z¹⁺ bond is not limited to a structure in which an ionic bond is formed, for example, the following organic pyrazabole compound is formed. The M¹⁻-Z^{1|} bond only has to be in a state of being stable as a molecular structure.

•X¹, X²

X¹ and X² each independently represents a carbon atom or a nitrogen atom. When X¹ and X² represent a nitrogen atom, R⁵ and R⁶ are not present.

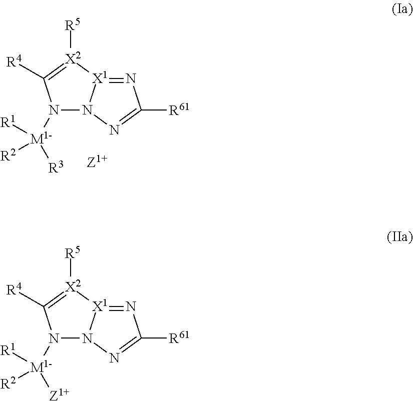

R¹ to R⁵, M¹, and Z¹ have the same definitions as in the formulae (I) and (II). R⁶¹ has the same definition as R⁶.

It is preferable that the formula (II) is represented by the following formula (III) or (IV),

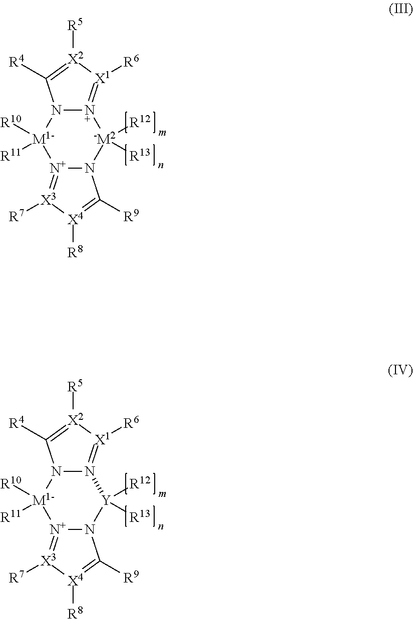

•R¹⁺ to R¹³

In the formulae (III) and (IV), R¹⁰ to R¹³ represent a halogen atom, an alkoxy group (preferably having 1 to 12 carbon atoms and more preferably having 1 to 6 carbon atoms), an aryloxy group (preferably having 6 to 22 carbon atoms and more preferably having 6 to 14 carbon atoms), an acyloxy group (preferably having 1 to 12 carbon atoms and more preferably having 1 to 6 carbon atoms), a heteroaryloxy group (preferably having 1 to 12 carbon atoms and more preferably having 2 to 5 carbon atoms), a sulfonyloxy group-containing group (R—SO₂—: R represents an alkyl group having 1 to 6 carbon atoms, an aryl group having 6 to 10 carbon atoms, an alkoxy group having 1 to 6 carbon atoms, or an acyl group having 1 to 6 carbon atoms), an alkyl group (preferably having 1 to 12 carbon atoms and more preferably having 1 to 6 carbon atoms), an aryl group (preferably having 6 to 22 carbon atoms and more preferably having 6 to 14 carbon atoms), or a heteroaryl group (preferably having 1 to 12 carbon atoms and more preferably having 2 to 5 carbon atoms). R¹⁰ to R¹³ may be bonded or condensed to each other to form a ring structure. As the heteroaryl group in the heteroaryloxy group and the heteroaryl group, the above-described examples of the heteroaryl group Ha are preferable.

•m, n

m and n represent an integer satisfying 0≦m+n≦3. When m and n represent 2 or more, two or more substituents defined therein may be different from each other.

•R⁴ to R⁹

R⁴ to R⁶ have the same definitions as in the formula (II) and, R⁷ to R⁹ have the same definitions as R⁴ to R⁶ in the formula (II).

•M¹ and M²

M¹ and M² represent a boron atom or an aluminum atom.

•Y

Y represents a metal atom other than a boron atom and an aluminum atom. As Y, for example, monovalent to pentavalent compounds are preferable, and a metal atom which is the example of the inorganic element Ya is more preferable.

•X¹ to X⁴

X¹ to X⁴ represent a carbon atom or a nitrogen atom, in which when X¹ to X⁴ represent a nitrogen atom, R⁵ to R⁸ are not present.

It is preferable that the formula (III) is represented by the following formula (V) or (VI).

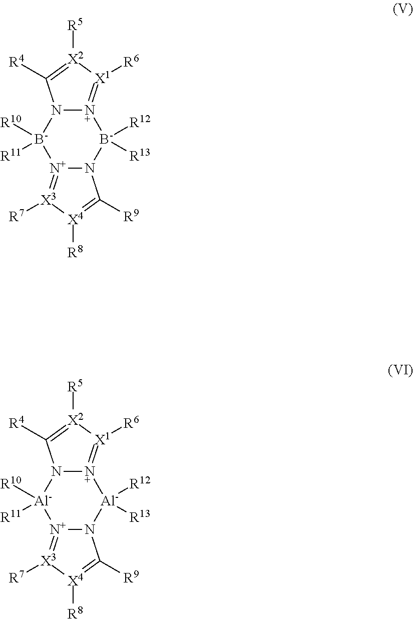

In the formulae (V) and (VI), R⁴ to R¹³ and X¹ to X⁴ have the same definitions as in the formula (III).

As the specific organic boron compound or organic aluminum compound, the following examples are shown but are not intended to limit the present invention. In the formulae (V) and (VI), Ph represents a phenyl group.

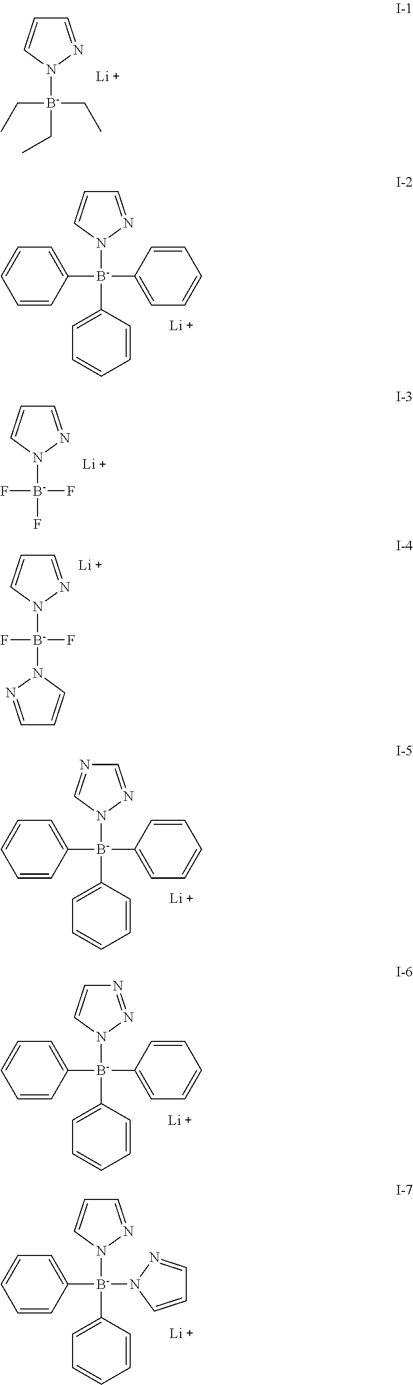

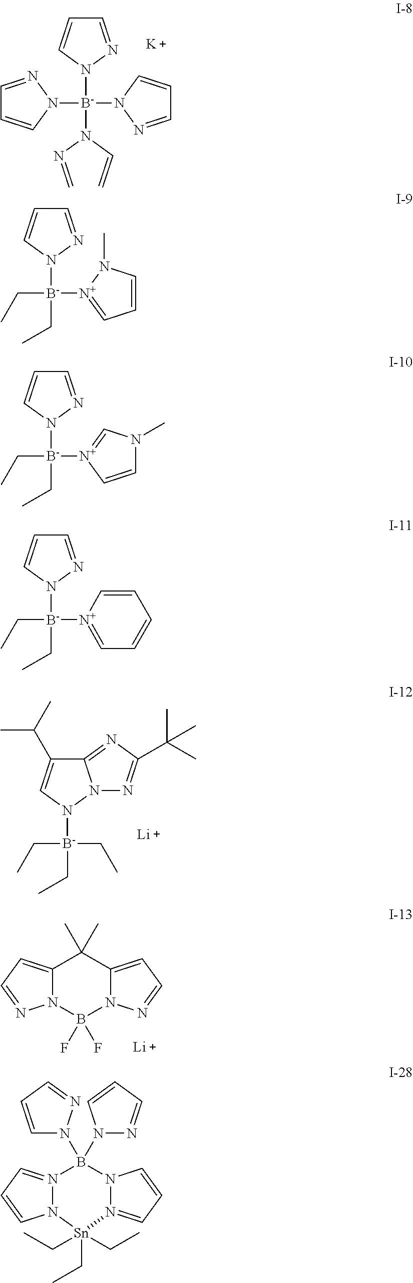

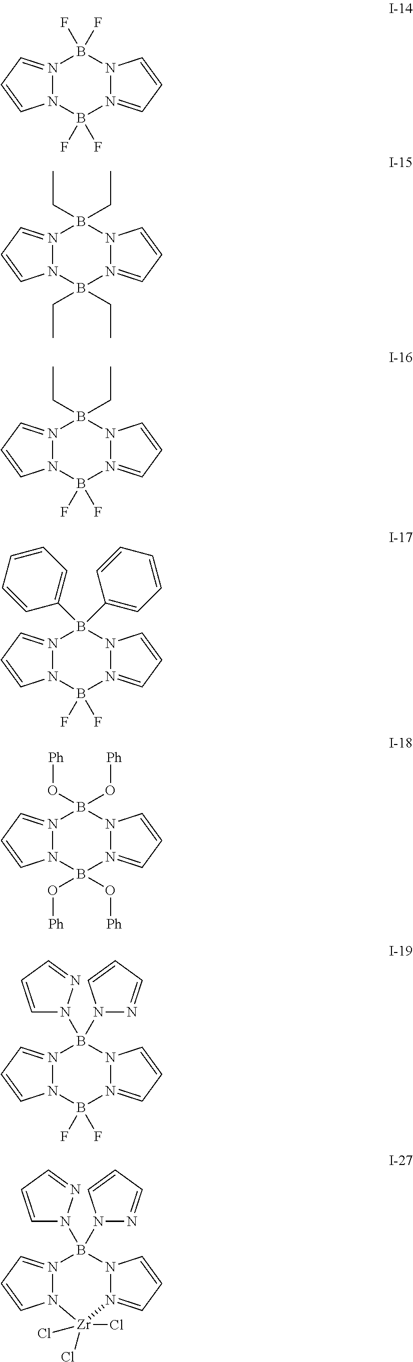

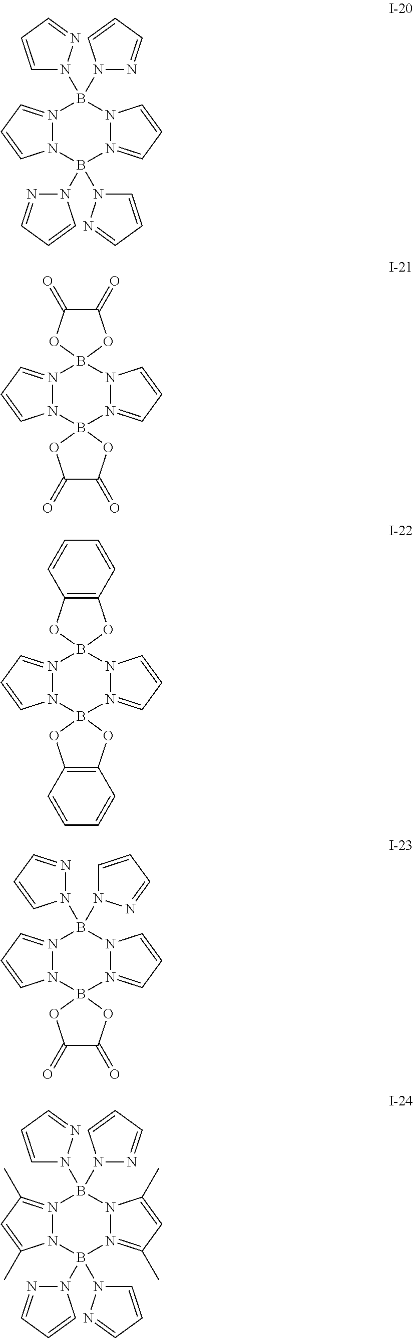

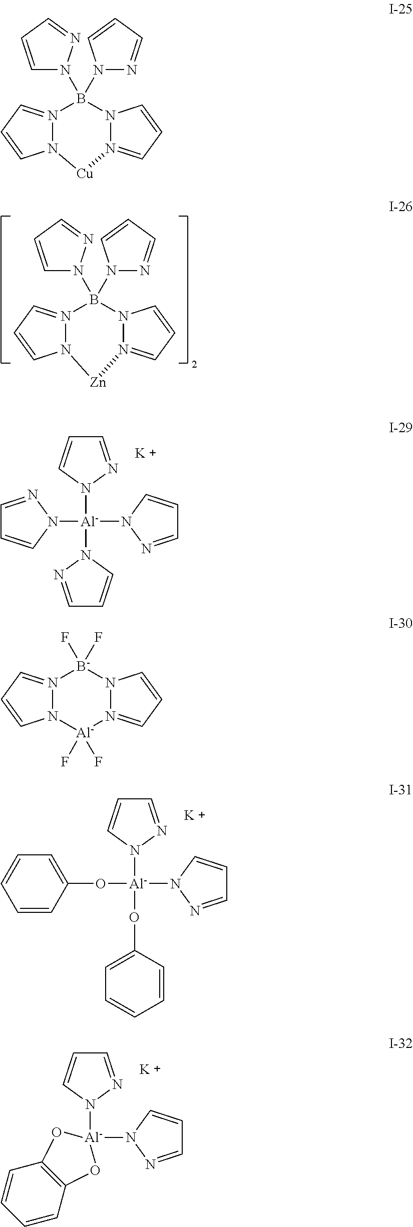

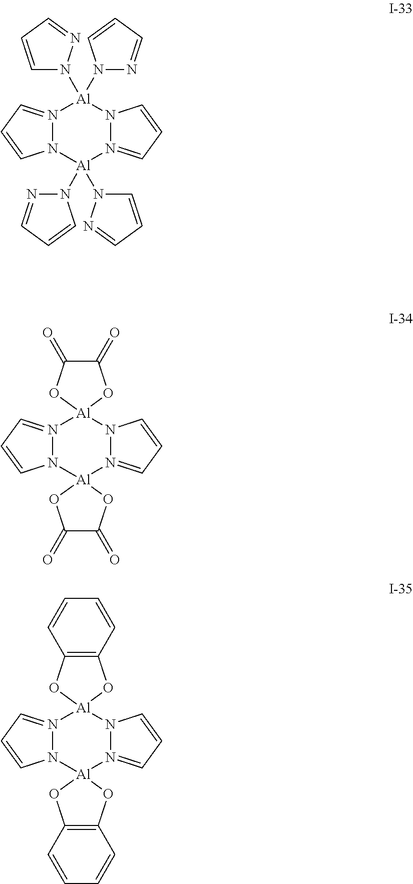

The reason why the specific organic boron compound or organic aluminum compound exhibits superior performance in overcharge preventing ability and deterioration suppressing ability is not completely clear, but is presumed to be as follows. First, for comparison, the behavior during the addition of pyrazole will be described as an example. It is considered that, in pyrazole, a free hydrogen atom thereof in the electrolytic solution is dissociated and bonded to Li⁺ as a charge carrier. As a result, this causes deterioration in operation performance such as a decrease in oxidation potential. By introducing a substituent into a site (N site) where the reaction with Li^{|} occurs, the deterioration is improved. Further, it is considered that, in the organic boron compound or organic aluminum compound according to the present invention, the bonding strength between the substituent thereof and N is high, and the stability as a compound is improved. Specifically, in the compound according to the present invention, the N-M (boron or aluminum) bond is not likely to be dissociated in the electrolytic solution and has high deterioration resistance. On the other hand, once dissociated, the compound according to the present invention is rapidly decomposed to exhibit the overcharge preventing ability. It can be understood that, through these actions, the deterioration resistance and the overcharge preventing ability, which are difficult to realize at the same time, can be satisfied.

The specific organic boron compound or organic aluminum compound can be synthesized referring to, for example, Journal of American Chemical Society 89, 19, 4948 to 4952.

The addition amount of the organic boron compound or organic aluminum compound with respect to the total amount of the electrolytic solution is preferably 0.001 mass % or more, more preferably 0.01 mass % or more, still more preferably 0.1 mass % or more, and even still more preferably 0.5 mass % or more. The upper limit is preferably 10 mass %% or less, more preferably 7 mass % or less, still more preferably 5 mass % or less, and even still more preferably 3 mass % or less. By selecting the addition amount in the preferred range, the safety during overcharge and the cell characteristics during normal use can be simultaneously realized.

The exemplary compounds may have an arbitrary substituent T.

Examples of the substituent T are as follows: an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, or 1-carboxymethyl); an alkenyl group (preferably an alkenyl group having 2 to 20 carbon atoms, for example, vinyl, allyl, or oleyl); an alkynyl group (preferably an alkynyl group having 2 to 20 carbon atoms, for example, ethynyl, butadiynyl, or phenyl-ethynyl); a cycloalkyl group (preferably a cycloalkyl group having 3 to 20 carbon atoms, for example, cyclopropyl, cyclopentyl, cyclohexyl, or 4-methylcyclohexyl); an aryl group (preferably an aryl group having 6 to 26 carbon atoms, for example, phenyl, 1-naphthyl, 4-methoxyphenyl, 2-chlorophenyl, or 3-methylphenyl); a heterocyclic group (preferably a heterocyclic group having 2 to 20 carbon atoms and more preferably a 5-membered or 6-membered heterocyclic group having at least one oxygen atom, sulfur atom, or nitrogen atom, for example, 2-pyridyl, 4-pyridyl, 2-imidazolyl, 2-benzimidazolyl, 2-thiazolyl, or 2-oxazolyl); an alkoxy group (preferably an alkoxy group having 1 to 20 carbon atoms, for example, methoxy, ethoxy, isopropyloxy, or benzyloxy); an aryloxy group (preferably an aryloxy group having 6 to 26 carbon atoms, for example, phenoxy, 1-naphthyloxy, 3-methylphenoxy, or 4-methoxyphenoxy); an alkoxycarbonyl group (preferably, an alkoxycarbonyl group having 2 to 20 carbon atoms, for example, ethoxycarbonyl or 2-ethylhexyloxycarbonyl); an amino group (preferably an amino group having 0 to 20 carbon atoms, an alkylamino group, or an arylamino group, for example, amino, N,N-dimethylamino, N,N-diethylamino, N-ethylamino, or anilino); a sulfamoyl group (preferably a sulfamoyl group having 0 to 20 carbon atoms, for example, N,N-dimethylsulfamoyl or N-phenylsulfamoyl); an acyl group (preferably an acyl group having 1 to 20 carbon atoms, for example, acetyl, propionyl, butyryl, or benzoyl); an acyloxy group (preferably an acyloxy group having 1 to 20 carbon atoms, for example, acetyloxy or benzoyloxy); a carbamoyl group (preferably a carbamoyl group having 1 to 20 carbon atoms, for example, N,N-dimethylcarbamoyl or N-phenylcarbamoyl); an acylamino group (preferably an acylamino group having 1 to 20 carbon atoms, for example, acetylamino or benzoylamino); a sulfonamide group (preferably a sulfonamide group having 0 to 20 carbon atoms, for example, methanesulfonamide, benzenesulfonamide, N-methylmethanesulfonamide, or N-ethylbenzenesulfonamide); an alkylthio group (preferably an alkylthio group having 1 to 20 carbon atoms, for example, methylthio, ethylthio, isopropylthio, or benzylthio); an arylthio group (preferably an arylthio group having 6 to 26 carbon atoms, for example, phenylthio, 1-naphthylthio, 3-methylphenylthio, or 4-methoxyphenylthio); an alkylsulfonyl or arylsulfonyl group (preferably an alkylsulfonyl or arylsulfonyl group having 1 to 20 carbon atoms, for example, methylsulfonyl, ethylsulfonyl, or benzenesulfonyl); a hydroxyl group; a cyano group; and a halogen atom (for example, a fluorine atom, a chlorine atom, a bromine atom, or an iodine atom). Among these, an alkyl group, an alkenyl group, an aryl group, a heterocyclic group, an alkoxy group, an aryloxy group, an alkoxycarbonyl group, an amino group, an acylamino group, a hydroxyl group, or a halogen atom is more preferable, and an alkyl group, an alkenyl group, a heterocyclic group, an alkoxy group, an alkoxycarbonyl group, an amino group, an acylamino group, or a hydroxyl group is still more preferable.

In addition, each exemplary group of the substituent T may be further substituted with the substituent T.

When a compound or a substituent, a linking group, or the like contains, for example, an alkyl group, an alkylene group, an alkenyl group, or an alkenylene group, these groups may be cyclic or branched, may be linear or branched, and may be substituted or unsubstituted as described above. In addition, when a compound or a substituent, a linking group, or the like contains, for example, an aryl group or a heterocyclic group, these groups may have a monocyclic or condensed ring and may be substituted or unsubstituted as described above.

(Organic Solvent)

The organic solvent used in the present invention is preferably a non-protonic organic solvent and more preferably a non-protonic organic solvent having 2 to 10 carbon atoms. The organic solvent is preferably a compound having an ether group, a carbonyl group, an ester group, or a carbonate group. The compound may have a substituent, and examples thereof include the substituent T.

Examples of the organic solvent include ethylene carbonate, propylene carbonate, butylene carbonate, dimethyl carbonate, diethyl carbonate, ethyl methyl carbonate, methyl propyl carbonate, γ-butyrolactone, γ-valerolactone, 1,2-dimethoxyethane, tetrahydrofuran, 2-methyl tetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, methyl trimethylacetate, ethyl trimethylacetate, acetonitrile, glutaronitrile, adiponitrile, methoxyacetonitrile, 3-methoxypropionitrile, N,N-dimethylformamide, N-methylpyrrolidinone, N-methyl oxazolidinone, N,N′-dimethylimidazolidinone, nitromethane, nitroethane, sulfolane, trimethyl phosphate, dimethyl sulfoxide, and dimethyl sulfoxide phosphate. Among these, one kind may be used alone, or two or more kinds may be used in combination. Among these, at least one selected from the group consisting of ethylene carbonate, propylene carbonate, dimethyl carbonate, diethyl carbonate, and ethyl methyl carbonate is preferable. In particular, a combination of a high viscosity (high dielectric constant) solvent (for example, relative dielectric constant ∈≧30) such as ethylene carbonate or propylene carbonate with a low viscosity solvent (for example, viscosity≦1 mPa·s) such as dimethyl carbonate, ethyl methyl carbonate, or diethyl carbonate is more preferable. This is because the dissociation of an electrolyte salt and the ionic mobility are improved.

However, the organic solvent used in the present invention is not limited to the above-described examples.

(Functional Additives)

The electrolytic solution according to the present invention preferably contains various functional additives. Examples of functions exhibited by the additives include a function of improving flame retardancy, a function of improving cycle characteristics, and a function of improving capacity characteristics. Hereinafter, examples of functional additives which are preferably applied to the electrolyte according to the present invention will be shown.

<Aromatic Compound (A)>

Examples of the aromatic compound include a biphenyl compound and an alkyl-substituted benzene compound. The biphenyl compound has a partial structure in which two benzene rings are bonded to each other through a single bond. The benzene rings may have a substituent, and examples of a preferable substituent include an alkyl group having 1 to 4 carbon atoms (for example, methyl, ethyl, propyl, or t-butyl) and an aryl group having 6 to 10 carbon atoms (for example, phenyl or naphthyl).

Specific examples of the biphenyl compound include biphenyl, o-terphenyl, m-terphenyl, p-terphenyl, 4-methylbiphenyl, 4-ethylbiphenyl, and 4-tert-butylbiphenyl.

As the alkyl-substituted benzene compound, a benzene compound that is substituted with an alkyl group having 1 to 10 carbon atoms is preferable, and specific examples thereof include cyclohexylbenzene, t-amyl benzene, and t-butyl benzene.

<Halogen-Containing Compound (B)>

As the halogen atom contained in the halogen-containing compound, a fluorine atom, a chlorine atom, or a bromine atom is preferable, and a fluorine atom is more preferable. The number of halogen atoms is preferably 1 to 6 and more preferably 1 to 3 As the halogen-containing compound, a carbonate compound that is substituted with a fluorine atom, a polyether compound having a fluorine atom, or a fluorine-substituted aromatic compound is preferable.

A halogen-substituted carbonate compound may be linear or branched. However, from the viewpoint of ion conductivity, a cyclic carbonate compound having high coordinating properties of an electrolyte salt (for example, a lithium ion) is preferable, and a 5-membered cyclic carbonate compound is more preferable.

Preferable examples of the halogen-substituted carbonate compound are as follows. Among these, compounds of Bex1 to Bex4 are more preferable, and Bex1 is still more preferable.

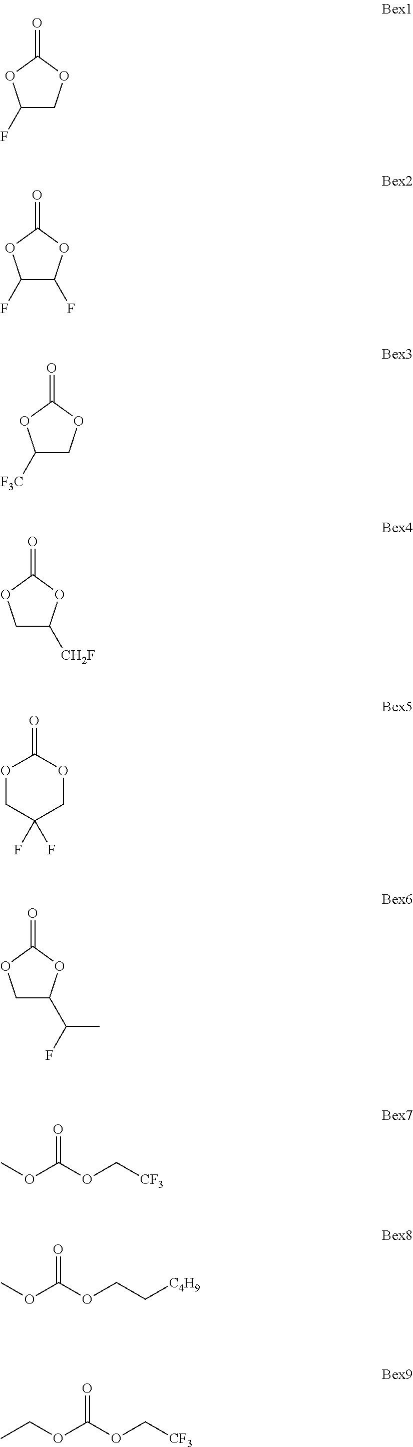

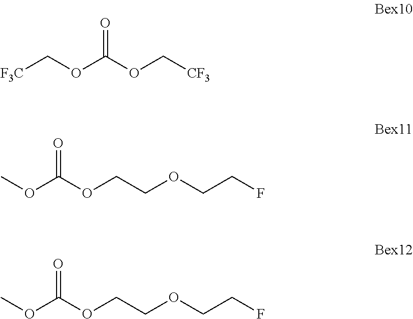

<Polymerizable Compound (C)>

As the polymerizable compound, a compound having a carbon-carbon double bond is preferable, a carbonate compound having a double bond such as vinylene carbonate or vinyl ethylene carbonate, a compound having a group selected from an acrylate group, a methacrylate group, a cyanoacrylate group, and an αCF₃ acrylate group, or a compound having a styryl group is more preferable, and a carbonate compound having a double bond or a compound having two or more polymerizable groups in the molecules is still more preferable.

<Phosphorus-Containing Compound (D)>

As the phosphorus-containing compound, a phosphate compound or a phosphazene compound is preferable. Preferable examples of the phosphate compound include trimethyl phosphate, triethyl phosphate, triphenyl phosphate, and tribenzyl phosphate. As the phosphorus-containing compound, a compound represented by the following formula (D2) or (D3) is also preferable.

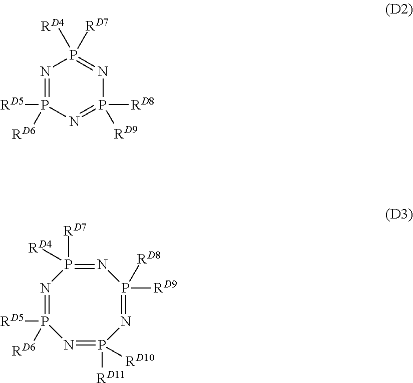

In the formulae (D2) and (D3), R^{D4} to R^{D11} represent a monovalent substituent. The monovalent substituent is preferably an alkyl group, an aryl group, an alkoxy group, an aryloxy group, an amino group, or a halogen atom such as a fluorine atom, a chlorine atom, or a bromine atom. At least one of substituents of R^{D4} to R^{D11} is preferably a fluorine atom and more preferably a substituent composed of an alkoxy group, an amino group, and a fluorine atom.

<Sulfur-Containing Compound (E)>

As the sulfur-containing compound, a compound having a —SO₂—, —SO₃—, or —OS(═O)O— bond is preferable, and a cyclic sulfur-containing compound such as propane sultone, propene sultone, or ethylene sulfite, or a sulfonic acid ester is more preferable.

As the cyclic sulfur-containing compound, a compound represented by the following formula (E1) or (E2) is preferable.

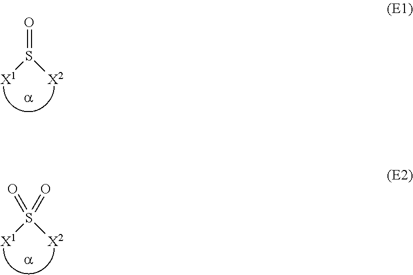

In the formula (E1) or (E2), X¹ and X² each independently represents —O— or —C(Ra)(Rb)—. Here, Ra and Rb each independently represents a hydrogen atom or a substituent. As the substituent, an alkyl group having 1 to 8 carbon atoms, a fluorine atom, or an aryl group having 6 to 12 carbon atoms is preferable. α represents an atom group required to form a 5-membered or 6-membered ring. A skeleton of α may contain not only a carbon atom but also a sulfur atom or an oxygen atom. α may have a substituent, and examples of the substituent include the substituent T. As the substituent, an alkyl group, a fluorine atom, or an aryl group is preferable.

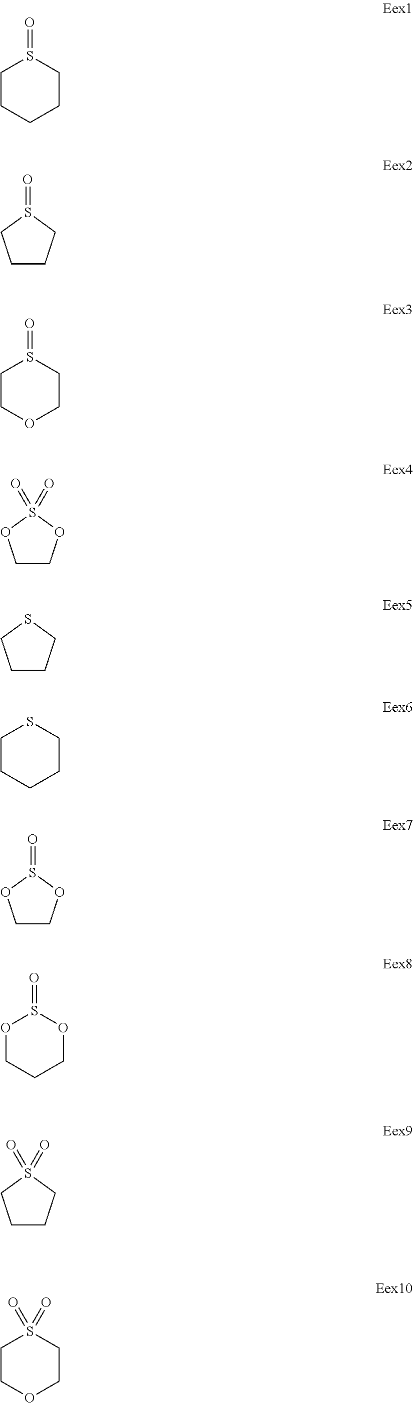

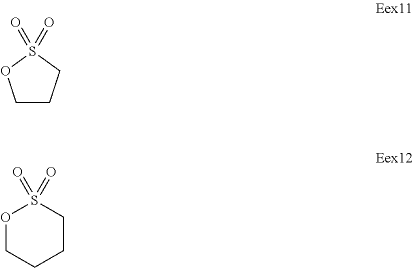 [SMILES: O=S1(=O)CCCO1 ; O=S1(=O)CCCCO1]

<Silicon-Containing Compound (F)>

As the silicon-containing compound, a compound represented by the following formula (F1) or (F2) is preferable.

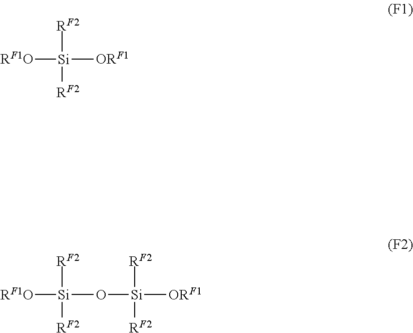

R^{F1} represents an alkyl group, an alkenyl group, an acyl group, an acyloxy group, or an alkoxycarbonyl group.

R^{F2} represents an alkyl group, an alkenyl group, an alkynyl group, or an alkoxy group.

Plural R^{F1}'s and R^{F2}'s which are present in the single formula may be the same as or different from each other, respectively.

<Nitrile Compound (G)>

As the nitrile compound, a compound represented by the following formula (G) is preferable.

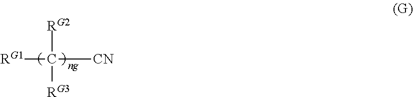

In the formula (G), R^{G1} to R^{G3} each independently represents a hydrogen atom, an alkyl group, an alkoxycarbonyl group, an aryloxycarbonyl group, a cyano group, a carbamoyl group, a sulfonyl group, or a phosphonyl group. Preferable examples of each substituent can refer to the examples of the substituent T. Among these, one or more of R^{G1} to R^{G3} preferably represent a compound which contains plural nitrile groups having a cyano group.

•Ng Represents an Integer of 1 to 8.

Specific preferable examples of the compound represented by the formula (G) include acetonitrile, propionitrile, isobutyronitrile, succinonitrile, malononitrile, glutaronitrile, adiponitrile, 2-methylglutaronitrile, hexanetricarbonitrile, and propanetetracarbonitrile. Among these, succinonitrile, malononitrile, glutaronitrile, adiponitrile, 2-methylglutaronitrile, hexanetricarbonitrile, or propanetetracarbonitrile is more preferable.

<Metal Complex Compound (H)>

As the metal complex compound, a transition metal complex or a rare earth metal complex is preferable. Among these, a complex represented by any one of the following formulae (H-1) to (H-3) is preferable.

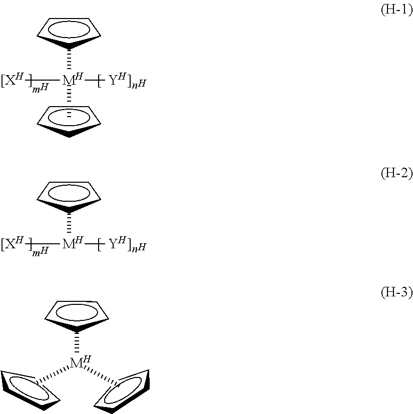

In the formulae (H-1) to (H-3), X^{H} and Y^{H} each independently represents a methyl group, an n-butyl group, a bis(trimethylsilyl)amino group, or a thioisocyanic acid group. X^{H} and Y^{H} may be condensed to form a cyclic alkenyl group (butadiene-coordinated metallacycle). In the formulae (H-1) to (H-3), M^{H} represents a transition element or a rare earth metal element. Specifically, as M^{H}, Fe, Ru, Cr, V, Ta, Mo, Ti, Zr, Hf, Y, La, Ce, Sw, Nd, Lu, Er, Yb, or Gd is preferable. m^{H} and n^{H} represent an integer satisfying 0≦m^{H}+n^{H}≦3. It is preferable that m^{H}+n^{H} is 1 or more. When m^{H} and n^{H} represent 2 or more, two or more groups defined therein may be different from each other.

It is preferable that the metal complex compound is a compound having a partial structure represented by the following formula (H-4).

M^{H-}(NR^{1H}R^{2H})q^{H} Formula (H-4)

In the formula (H-4), M^{H} represents a transition element or a rare earth metal element and has the same definition as in the formulae (H-1) to (H-3).

R^{1H} and R^{2H} represent a hydrogen atom, an alkyl group (preferably having 1 to 6 carbon atoms), an alkenyl group (preferably having 2 to 6 carbon atoms), an alkynyl group (preferably having 2 to 6 carbon atoms), an aryl group (preferably having 6 to 14 carbon atoms), an heteroaryl group (preferably having 3 to 6 carbon atoms), an alkylsilyl group (preferably having 1 to 6 carbon atoms), or a halogen atom. R^{1H} and R^{2H} may be linked to each other. R^{1H} and R^{2H} may each independently form a ring or may be linked to each other to form a ring. Preferable Examples of R^{1H} and R^{2H} include examples of a substituent T described above. Among these, a methyl group, an ethyl group, or a trimethylsilyl group is preferable.

q^{H} represents an integer of 1 to 4, preferably an integer of 2 to 4, and more preferably 2 or 4. When q^{H} represents 2 or more, plural groups defined therein may be the same as or different from each other.

Specific examples of the metal complex compound will be shown below. TMS represents a trimethylsilyl group.

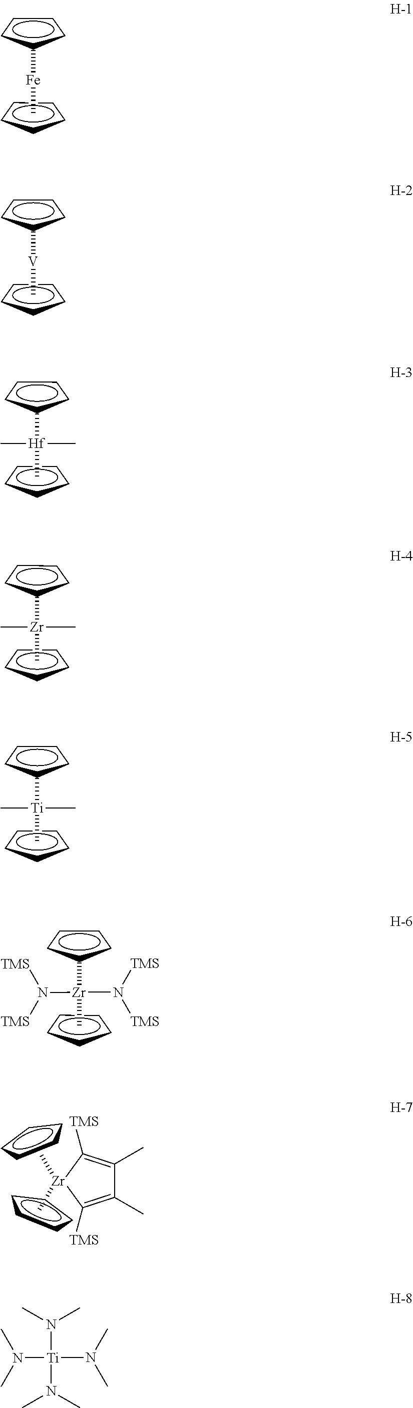

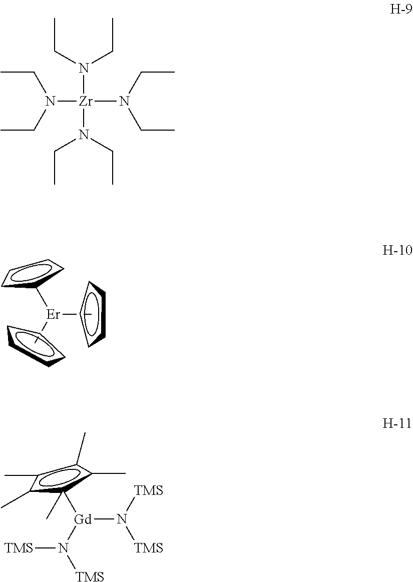

As the metal complex compound, a compound represented by any one of the following formulae is preferable.

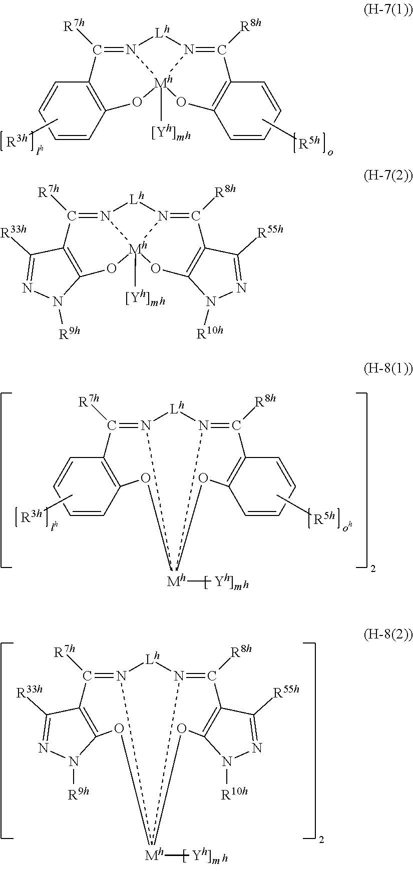

•M^{h}

As a central metal M^{h}, Ti, Zr, ZrO, Hf, V, Cr, Fe, or Ce is more preferable, and Ti, Zr, Hf, V, or Cr is most preferable.

•R^{3h}, R^{5h}, R^{7h} to R^{10h}

R^{3h}, R^{5h}, and R^{7h} to R^{10h} represent a substituent. Among these, an alkyl group, an alkoxy group, an aryl group, an alkenyl group, or a halogen atom is preferable, an alkyl group having 1 to 6 carbon atoms, an alkoxy group having 1 to 6 carbon atoms, an aryl group having 6 to 12 carbon atoms, or an alkenyl group having 2 to 6 carbon atoms is more preferable, and methyl, ethyl, propyl, isopropyl, isobutyl, t-butyl, perfluoromethyl, methoxy, phenyl, or ethenyl is still more preferable.

•R^{33h}, R^{55h}

R^{33h} and R^{55h} represent a hydrogen atom or a substituent of R^{3h}.

•Y^{h}

As Y^{h}, an alkyl group having 1 to 6 carbon atoms or a bis(trialkylsilyl)amino group is preferable, and a methyl group or a bis(trimethylsilyl)amino group is more preferable.

•l^{h}, m^{h} o^{h}

l^{h}, m^{h}, and o^{h} represent an integer of 0 to 3 and preferably an integer of 0 to 2. When l^{h}, m^{h}, and o^{h} represent 2 or more, plural structural units defined therein may be the same as or different from each other.

•L^{h}

As L^{h}, an alkylene group or an arylene group is preferable, a cycloalkylene group having 3 to 6 carbon atoms or an arylene group having 6 to 14 carbon atoms is more preferable, and cyclohexylene or phenylene is still more preferable.

Specific examples of the specific organic metal compound will be shown below, but the present invention is not intended to be limited thereto.

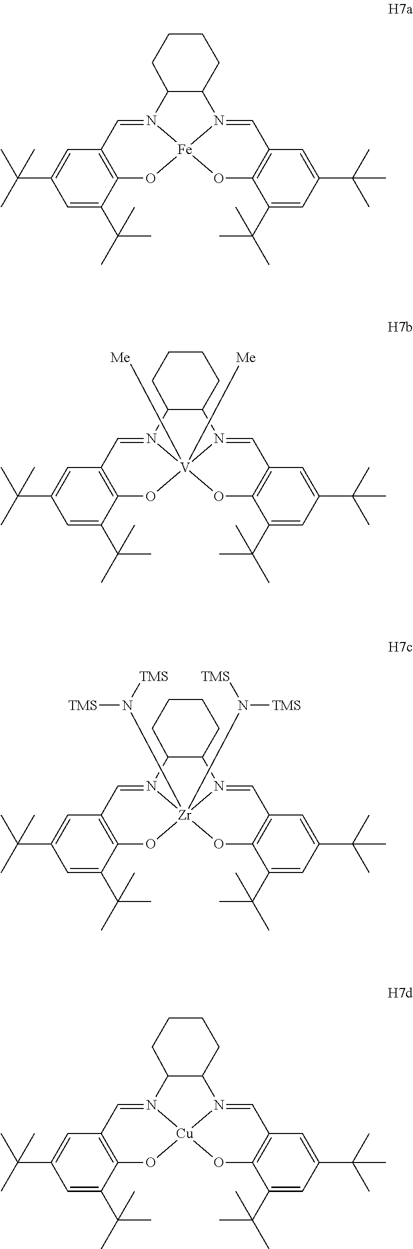

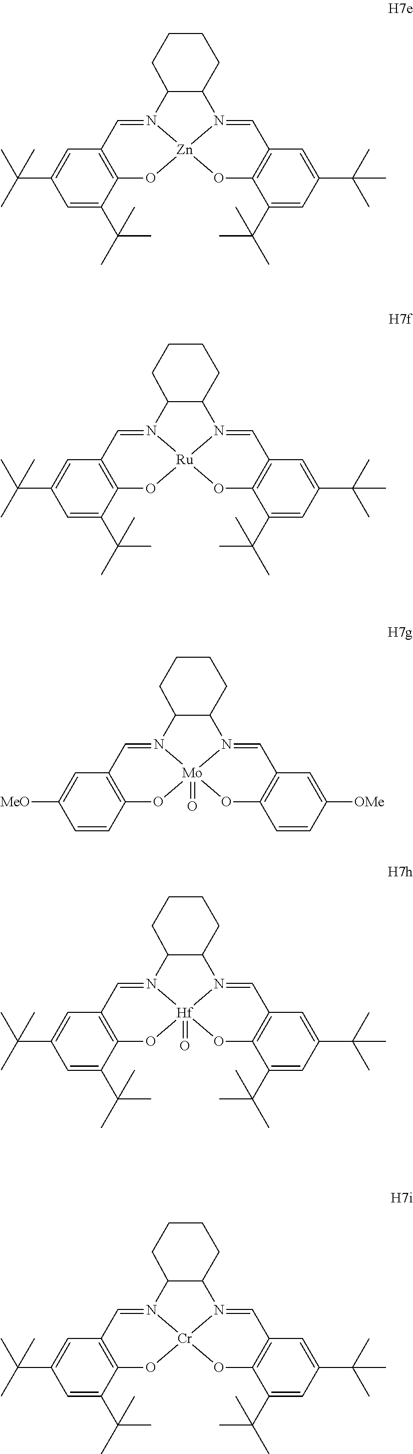

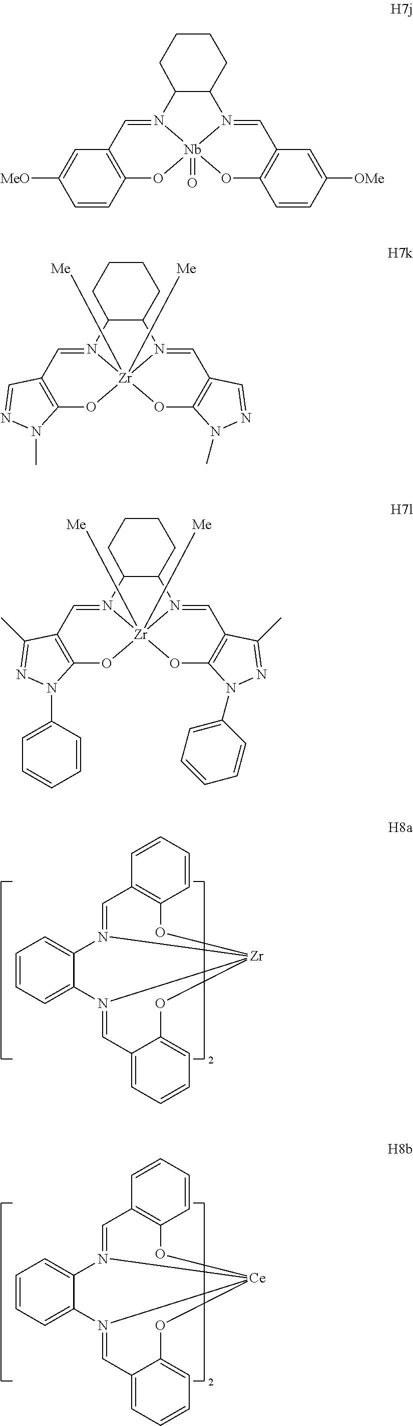

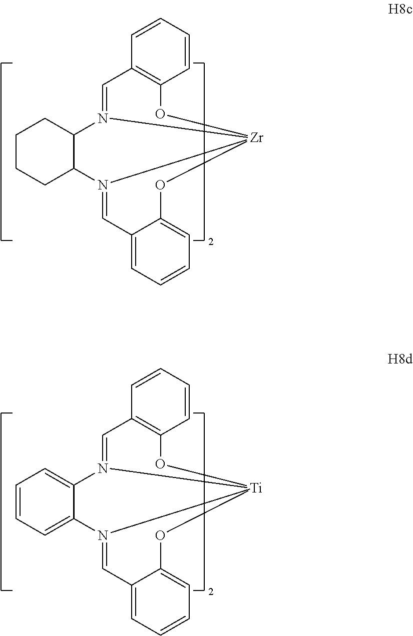

<Imide Compound (I)>

As the imide compound, from the viewpoint of obtaining oxidation resistance, a sulfonimide compound having a perfluoro group is preferable, and specific examples thereof include a perfluorosulfonimide lithium compound.

Specific examples of the imide compound include compounds having the following structures. Among these, Cex1 or Cex2 is more preferable.

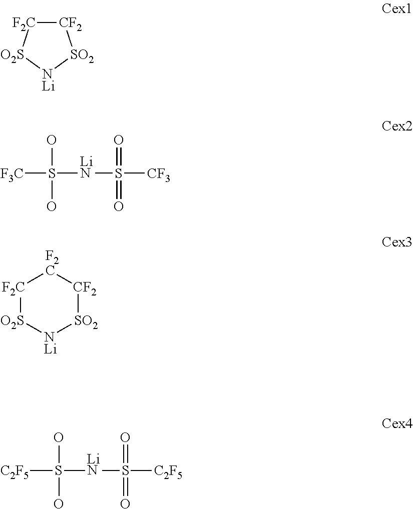

The electrolytic solution according to the present invention may contain at least one selected from the above-described additives, a negative electrode film forming agent, a flame retardant, and an overcharge inhibitor. The content ratio of each of these functional additives in the non-aqueous electrolytic solution is not particularly limited, but is preferably 0.001 mass % to 10 mass % with respect to the total mass of the non-aqueous electrolytic solution. Due to the addition of these compounds, the bursting and ignition of a cell during an abnormal situation caused by overcharge can be suppressed, and capacity retention characteristics and cycle characteristics after high-temperature storage can be improved.

(Electrolyte)

As the electrolyte which is used in the electrolytic solution according to the present invention, a metal ion in Group 1 or Group 2 of the periodic table or a salt thereof is used. The electrolyte can be appropriately selected according to the intended purpose of the electrolytic solution, and examples thereof include a lithium salt, a potassium salt, a sodium salt, a calcium salt, and a magnesium salt. When the electrolyte is used in a secondary cell or the like, a lithium salt is preferable from the viewpoint of obtaining high output. When the electrolytic solution according to the present invention is used for an electrolyte of a non-aqueous electrolytic solution for a lithium secondary cell, a lithium salt is preferably selected as a salt of a metal ion. The lithium salt is not particularly limited as long as it can be typically used for an electrolyte of a non-aqueous electrolytic solution for a lithium secondary cell. Preferable examples of the lithium salt are as follows.

(L-1): inorganic lithium salts including: inorganic fluoride salts such as LiPF₆, LiBF₄, LiAsF₆, and LiSbF₆; perhalogenate salts such as LiClO₄, LiBrO₄, and LiIO₄; and inorganic chloride salts such as LiAlCl₄.

(L-2): fluorine-containing organic lithium salts including: perfluoroalkanesulfonate salts such as LiCF₃SO₃; perfluoroalkanesulfonylimide salts such as LiN(CF₃SO₂)₂, LiN(CF₃CF₂SO₂)₂, LiN(FSO₂)₂, and LiN(CF₃SO₂)(C₄F₉SO₂); perfluoroalkanesulfonylmethide salts such as LiC(CF₃SO₂)₃; fluoroalkyl fluorophosphates such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃)₂], and Li[PF₃(CF₂CF₂CF₂CF₃)₃].

(L-3): oxalato borates including: lithium bis(oxalato)borate and lithium difluoro(oxalato) borate.

Among these, LiPF₆, LiBF₄, LiAsF₆, LiSbF₆, LiClO₄, Li(Rf¹SO₃), LiN(Rf¹SO₂)₂, LiN(FSO₂)₂, and LiN(Rf¹SO₂)(Rf²SO₂)₂ are preferable, and lithium imide salts such as LiPF₆, LiBF₄, LiN(Rf¹SO₂)₂, LiN(FSO₂)₂, and LiN(Rf¹SO₂)(Rf²SO₂)₂ are more preferable. Here, Rf¹ and Rf² each independently represents a perfluoroalkyl group.

Among these electrolytes used in the electrolytic solution, one kind may be used alone, or two or more kinds may be used in an arbitrary combination.

The content of the electrolyte (an ion or a salt of a metal in Group 1 or Group 2 in the periodic table) in the electrolytic solution is adjusted such that a preferable salt concentration described in the following preparation method of the electrolytic solution is obtained. This salt concentration can be appropriately selected according to the intended purpose of the electrolytic solution. In general, the salt concentration is preferably 10 mass % to 50 mass % and more preferably 15 mass % to 30 mass % with respect to the total mass of the electrolytic solution. When being evaluated as the ion concentration, the content may be calculated in terms of a salt thereof with a metal which is preferably used.

[Preparation Method of Electrolytic Solution and the Like]

The electrolytic solution for a non-aqueous secondary cell according to the present invention can be prepared with a conventional method by dissolving the above-described respective components in the above-described solvent for a non-aqueous electrolytic solution, the components including the example in which a lithium salt is used as a salt of a metal ion.

In the present invention, “non-aqueous” represents substantially not containing water. The non-aqueous electrolytic solution may contain a small amount of water in a range where the effects of the present invention do not deteriorate. In consideration of obtaining superior characteristics, the content of water is preferably 200 ppm or lower (in terms of mass), more preferably 100 ppm or lower, and still more preferably 20 ppm or lower. The lower limit is not particularly limited but, in practice, is 1 ppm or higher in consideration of unavoidable incorporation. The viscosity of the electrolytic solution according to the present invention is not particularly limited, but the viscosity at 25° C. is preferably 10 mPa·s to 0.1 mPa·s and more preferably 5 mPa·s to 0.5 mPa·s.

In the present invention, the viscosity of the electrolytic solution is a value measured using the following measurement method unless specified otherwise.

<Method of Measuring Viscosity>

The viscosity refers to a value measured using the following method. 1 mL of a sample is put into a rheometer (CLS 500), and the viscosity thereof is measured using Steel Cone (manufactured by TA Instruments) having a diameter of 4 cm/2°. The sample is warmed in advance until the temperature is constant at a measurement start temperature, and then the measurement is started. The measurement temperature is set as 25° C.

[Secondary Cell]

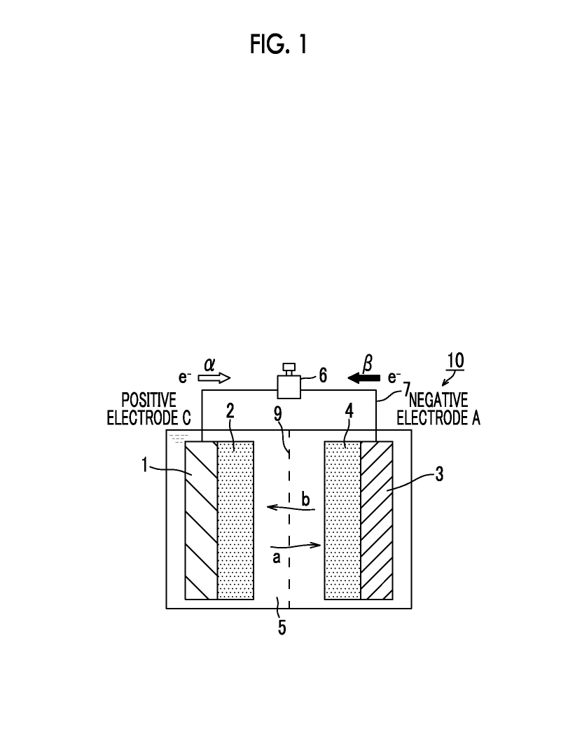

It is preferable that a non-aqueous secondary cell according to the present invention contains the non-aqueous electrolytic solution. A lithium ion secondary cell according to a preferred embodiment of the present invention will be described with reference to FIG. 1 schematically showing a mechanism thereof. The lithium ion secondary cell 10 according to the embodiment includes: the above-described electrolytic solution 5 for a non-aqueous secondary cell according to the present invention; a positive electrode C (including a positive electrode current collector 1 and a positive electrode active material layer 2) capable of storing and releasing lithium ions; and a negative electrode A (including a negative electrode current collector 3 and a negative electrode active material layer 4) capable of storing and releasing or dissolving or depositing lithium ions. In addition to these essential components, the lithium ion secondary cell 10 may further include, for example, a separator 9 that is disposed between the positive electrode and the negative electrode, a current collector terminal (not shown), and an outer case (not shown) in consideration of the intended use of the cell, the form of the potential, and the like. Optionally, a protective element may be mounted at least either inside or outside the cell. With such a structure, lithium ions in the electrolytic solution 5 are stored (a) and released (b), the cell can be charged (α) and discharged (β), and an operating mechanism 6 can operate and store electricity through a circuit wiring 7. Hereinafter, the configuration of the lithium secondary cell which is a preferred embodiment of the present invention will be described in more detail.

(Cell Shape)

The cell shape which is applied to the lithium secondary cell according to the embodiment is not particularly limited and may be, for example, a bottomed cylindrical shape, a bottomed square shape, a thin shape, a sheet shape, a paper shape, and a combination thereof. In addition, the cell shape may be a horseshoe shape or a comb shape in consideration of the form of a system or an apparatus to be incorporated. From the viewpoints of efficiently dissipating heat generated in the cell to the outside, the cell shape is preferably a square shape such as a bottomed square shape or a thin shape having at least one relatively flat surface with a large area.

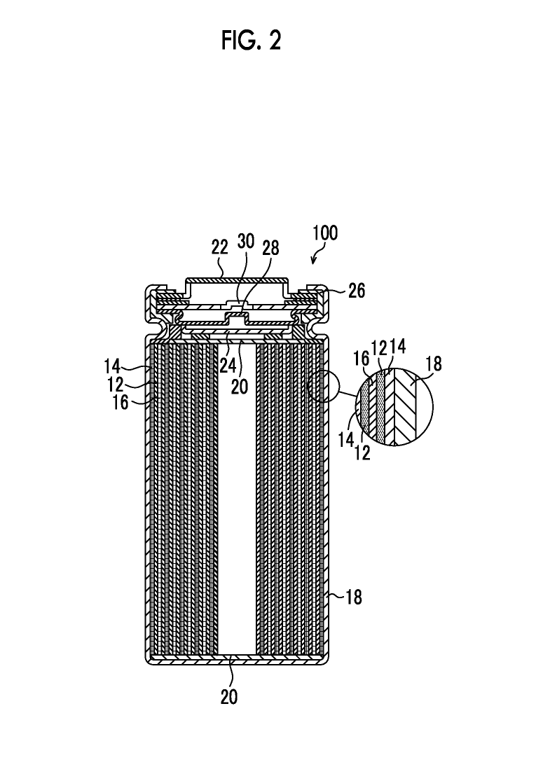

In a bottomed cylindrical cell, the outer surface area relative to a power generating element to be charged is reduced. Therefore, the cell preferably has a design in which Joule's heat generated due to internal resistance during charging or discharging is efficiently dissipated to the outside. In addition, the cell preferably has a design in which the packing ratio of a material having high thermal conductivity is improved so as to decrease an internal temperature distribution. FIG. 2 shows an example of the bottomed cylindrical lithium secondary cell 100. In this bottomed cylindrical lithium secondary cell 100, a wound laminate where a positive electrode sheet 14 and a negative electrode sheet 16 are superimposed with a separator 12 interposed therebetween is accommodated in an outer can 18.

In a bottomed square cell, it is preferable that a ratio 2S/T of a value two times the area S (the product of the width and the height of the external dimension excluding a terminal portion; unit: cm²) of the largest surface to the thickness T (unit: cm) of the external shape of the cell is preferably 100 or more and more preferably 200 or more. By increasing the area of the largest surface, even in a cell having high output and high capacity, characteristics such as cycle characteristics or high-temperature storage characteristics can be improved, and heat dissipation efficiency during abnormal heat generation can be improved. As a result, the cell can be prevented from being in a “valve operating state” or “bursting state”.

(Components Constituting Cell)

Referring to FIG. 1, the lithium secondary cell according to the embodiment includes the electrolytic solution 5, the positive electrode and the negative electrode C and A which are electrode mixtures, and the separator 9 which is a base component. Hereinafter, the respective components will be described. The non-aqueous secondary cell according to the present invention includes at least the electrolytic solution for a non-aqueous secondary cell according to the present invention as an electrolytic solution.

(Electrode Mixture)

The electrode mixture is obtained by coating a current collector (electrode base material) with a dispersion of an active material, a conductive material, a binder, a filler, and the like. In a lithium cell, it is preferable that a positive electrode mixture including a positive electrode active material as an active material and a negative electrode mixture including a negative electrode active material as an active material are used. Next, the respective components in the dispersion (the electrode composition) constituting the electrode mixture will be described.

•Positive Electrode Active Material

As the positive electrode active material, a transition metal oxide is preferable. It is preferable that the transition metal oxide contains a transition element M^{a} (at least one element selected from Co, Ni, Fe, Mn, Cu, and V). In addition, a mixing element M^{b} (for example, elements other than lithium in Group 1 (Ia) of the periodic table and elements in Group 2 (IIa) of the periodic table), Al, Ga, In, Ge, Sn, Pb, Sb, Bi, Si, P, or B) may be mixed with the transition metal oxide. Examples of the transition metal oxide include a specific transition metal oxide which contains a compound represented by any one of the following formulae (MA) to (MC); and other transition metal oxides such as V₂O₅ and MnO₂. As the positive electrode active material, a particulate positive electrode active material may be used. Specifically, a transition metal oxide that can reversibly store and release lithium ions can be used, and the specific transition metal oxide is preferably used.

The positive electrode active material is preferably a material having a sufficient charging region or a transition metal oxide material that can store and release alkali metal ions. Specifically, the transition metal oxide has a lithium storage-release potential peak of preferably 3.5 V or higher, more preferably 3.8 V or higher, and most preferably 4.0 V or higher vs. lithium. At this time, the charge-discharge potential peak can be specified by preparing a three-electrode cell, which includes a working electrode, a reference electrode, and a counter electrode, and performing electrochemical measurement (cyclic voltammetry) thereon. The configuration of the three-electrode cell and the measurement conditions of the electrochemical measurement are as follows.

<Configuration of Three-Electrode Cell>

Working electrode: an active material electrode which is formed on a platinum electrode using a sol-gel method or a sputtering method

Reference electrode: lithium Counter electrode: lithium

Dilution medium: EC/EMC=1/2, LiPF₆, 1M, manufactured by Kishida Chemical Co., Ltd.

### <Measurement Conditions>

Scanning rate: 1 mV/s

Measurement temperature: 25° C.

As the transition metal oxide, for example, an oxide containing the transition element M^{a} is preferable. At this time, the oxide containing the transition element M^{a} may be mixed with the mixing element M^{b} (preferably Al). The mixing amount is preferably 0 mol % to 30 mol % with respect to the amount of the transition metal. It is more preferable that the lithium-containing transition metal oxide is synthesized by mixing the above components such that a molar ratio Li/M^{a} is 0.3 to 2.2.

[Transition Metal Oxide Represented by Formula (MA) (Layered Rock Salt Structure)]

As the lithium-containing transition metal oxide, a compound represented by the following formula (MA) is preferable.

LiₐM¹O_{b} (MA)

In the formula (MA), M¹ has the same definition as M^{a} described above. a represents 0 to 1.2 and preferably 0.6 to 1.1. b represents 1 to 3 and preferably 2. A portion of M¹ may be substituted with the mixing element M^{b}. The transition metal oxide represented by the formula (MA) typically has a layered rock salt structure.

As this transition metal oxide, a compound represented by each of the following formulae is more preferable.

Li_{g}CoOₖ (MA-1)

Li_{g}NiOₖ (MA-2)

Li_{g}MnOₖ (MA-3)

Li_{g}CoⱼNi₁₋ⱼOₖ (MA-4)

Li_{g}NiⱼMn₁₋ⱼOₖ (MA-5)

Li_{g}CoⱼNiᵢAl₁₋ⱼ₋ᵢOₖ (MA-6)

Li_{g}CoⱼNiᵢMn₁₋ⱼ₋ᵢOₖ (MA-7)

In the formulae (MA-1) to (MA-7), g has the same definition as a described above. j represents 0.1 to 0.9. i represents 0 to 1, in which 1-j-i represents 0 or more. k has the same definition as b. Specific examples of the transition metal compound include LiCoO₂ (lithium cobalt oxide), LiNi₂O₂ (lithium nickel oxide), LiNi_{0.85}Co_{0.01}Al_{0.05}O₂ (lithium nickel cobalt aluminum oxide; [NCA]), LiNi_{0.33}Co_{0.33}Mn_{0.33}O₂ (lithium nickel manganese cobalt oxide [NMC]), and LiNi_{0.5}Mn_{0.5}O₂ (lithium manganese nickel oxide).

Preferable examples of the transition metal oxide represented by the formula (MA) also include compounds represented by the following formula (some of the compounds are the same as the above-described examples, but different symbols are used)

Li_{g}NiₓMn_{y}Co_{z}O₂ (x>0.2, y>0.2, z≧0, x+y+z=1) (i)

representative example:

Li_{g}Ni_{1/3}Mn_{1/3}CO_{1/3}O₂

Li_{g}Ni_{1/2}Mn_{1/2}O₂

Li_{g}NiₓCo_{y}Al_{z}O₂ (x>0.7, y>0.1, 0.1>z>0.05, x+y+z=1) (ii)

representative example:

Li_{g}Ni_{0.8}Co_{0.15}Al_{0.05}O₂

[Transition Metal Oxide Represented by Formula (MB) (Spinel Structure)]

As the lithium-containing transition metal oxide, a compound represented the following formula (MB) is also preferable.

Li_{c}M²₂O_{d} (MB)

In the formula (MB), M² has the same definition as M^{a} described above. c represents 0 to 2 and preferably 0.6 to 1.5. d represents 3 to 5 and preferably 4.

As the transition metal oxide represented by the formula (MB), a compound represented by each of the following formulae is more preferable.

LiₘMn₂Oₙ (MB-1)

LiₘMnₚAl₂₋ₚOₙ (MB-2)

LiₘMnₚNi₂₋ₚOₙ (MB-3)

m has the same definition as c. n has the same definition as d. p represents 0 to 2. Specific examples of the transition metal compound include LiMn₂O₄ and LiMn_{1.5}Ni_{0.5}O₄.

Preferable examples of the transition metal oxide represented by the formula (MB) also include compounds represented by the following formulae.

LiCoMnO₄ (a)

Li₂FeMn₃O₈ (b)

Li₂CuMn₃O₈ (c)

Li₂CrMn₃O₈ (d)

Li₂NiMn₃O₈ (e)

From the viewpoints of high capacity and high output, an electrode containing Ni is still more preferable among the above-described electrodes.

[Transition Metal Oxide Represented by Formula (MC)]

As the lithium-containing transition metal oxide, a lithium-containing transition metal phosphorus oxide is preferably used, and a compound represented by the following formula (MC) is more preferable.

LiₑM³(PO₄)_{f} (MC)

In the formula (MC), e represents 0 to 2 and preferably 0.5 to 1.5. f represents 1 to 5 and preferably 0.5 to 2.

M³ represents one or more elements selected from V, Ti, Cr, Mn, Fe, Co, Ni, and Cu. M³ may be substituted with other metals such as Ti, Cr, Zn, Zr, or Nb instead of the mixing element M^{b}. Specific examples of M³ include olivine-type iron phosphates such as LiFePO₄ and Li₃Fe₂(PO₄)₃; iron pyrophosphates such as LiFeP₂O₇; cobalt phosphates such as LiCoPO₄; and monoclinic NASICON type vanadium phosphates such as Li₃V₂(PO₄)₃ (lithium vanadium phosphate).

The values of a, c, g, m, and e representing the composition of Li vary depending on charging and discharging conditions. Typically, these values are evaluated in a stable state of the cell containing Li. In the formulae (a) to (e), the specific values represent the composition of Li. However, these values also vary depending on the operation of the cell.

In the present invention, as the positive electrode active material, a material capable of maintaining normal use at a positive electrode potential (vs. Li/Li^{|}) of 4.25 V or higher is preferably used. Being capable of maintaining normal use described herein represents that a cell does not become unused due to deterioration of an electrode material even when being charged at the above voltage, and this potential may also be referred to as “normal-usable potential”. This potential may also be referred to simply as “positive electrode potential”. The positive electrode potential (normal-usable potential) is more preferably 4.3 V or higher. The upper limit of the positive electrode potential is not particularly limited, but is practically 5 V or lower.

In the above-described range, cycle characteristics and high-rate discharging characteristics can be improved.

[Method of Measuring Electrode Potential (Vs. Li/Li⁺)]

The positive electrode potential during charging is obtained from the following expression.

(Positive Electrode Potential)=(Negative Electrode Potential)+(Cell Voltage)

When lithium titanium oxide is used as the negative electrode, the negative electrode potential is 1.55 V. When graphite is used as the negative electrode, the negative electrode potential is 0.1 V. During charging, the cell voltage is observed, and the positive electrode potential is calculated therefrom.

In the non-aqueous secondary cell according to the present invention, the average particle size of the positive electrode active material to be used is not particularly limited but is preferably 0.1 μm to 50 μm. The specific surface area is not particularly limited but is preferably 0.01 m²/g to 50 m²/g when measured using the BET method. In addition, when 5 g of the positive electrode active material is dissolved in 100 ml of distilled water, the pH of the supernatant liquid is preferably 7 to 12.

In order for the positive electrode active material to have the predetermined particle size, a well-known pulverizer or classifier is used. For example, a mortar, a ball mill, a vibration ball mill, a vibration mill, a satellite ball mill, a planetary ball mill, a swirling air flow jet mill, or a sieve is used. The positive electrode active material obtained using the calcination method may be used after being washed with water, an acidic aqueous solution, an alkaline aqueous solution, or an organic solvent.

The mixing amount of the positive electrode active material is not particularly limited, but the mixing amount in the dispersion (mixture) constituting the active material layer is preferably 60 mass % to 98 mass % and more preferably 70 mass % to 95 mass % with respect to 100 mass % of the solid components.

•Negative Electrode Active Material

The negative electrode active material is not particularly limited as long as it can reversibly store and release lithium ions, and examples thereof include carbonaceous materials; metal oxides such as tin oxide and silicon oxide; metal composite oxides; lithium and lithium alloys such as a lithium-aluminum alloy; and metals capable of forming an alloy with lithium, such as Sn and Si.

Among these, one kind may be used alone, or two or more kinds may be used in an arbitrary combination at an arbitrary ratio. Among these, carbonaceous material or lithium metal composite oxides are preferably used from the viewpoint of safety.

In addition, the metal composite oxide is not particularly limited as long as it can store and release lithium, but it is preferable that the metal composite oxide contains titanium and/or lithium as a constituent element from the viewpoint of high current density charging-discharging characteristics.

The carbonaceous material which is used as the negative electrode active material is a material substantially containing carbon. Examples of the carbonaceous material include petroleum pitch, natural graphite, artificial graphite such as vapor-grown graphite, and carbonaceous materials obtained by firing various synthetic resins such as PAN resins and furfuryl alcohol resins. Further, other examples of the carbonaceous material include various carbon fibers such as PAN-based carbon fibers, cellulose-based carbon fibers, pitch-based carbon fibers, vapor-grown carbon fibers, dehydrated PVA-based carbon fibers, lignin carbon fibers, vitreous carbon fibers, activated carbon fibers; mesophase microspheres; graphite whiskers; and tabular graphite.

These carbonaceous materials can be classified into non-graphitizable carbonaceous materials and graphitizable carbonaceous materials based on the graphitization degree. In addition, it is preferable that the carbonaceous material has the lattice spacing, density, and crystallite size described in JP1987-22066A (JP-S62-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JPH5-90844A) or graphite having a coating layer described in JP1994-4516A (JPH6-4516A).

The metal oxide and the metal composite oxide, which are negative electrode active materials used in the non-aqueous secondary cell according to the present invention, are not particularly limited as long as at least one thereof is included. The metal oxide and the metal composite oxide are more preferably amorphous oxides. Further, chalcogenides which are reaction products between metal elements and elements in Group 16 of the periodic table are preferably used. “Amorphous” described herein represents an oxide having a broad scattering band with a peak in a range of 20° to 40° in terms of 28 when measured by an X-ray diffraction method using CuKα rays, and the oxide may have a crystal diffraction line. The highest intensity in a crystal diffraction line observed in a range of 40° to 70° in terms of 2θ is preferably 100 times or less and more preferably 5 times or less relative to the intensity of a diffraction peak line in a broad scattering band observed in a range of 20° to 40° in terms of 20, and it is still more preferable that the oxide does not have a crystal diffraction line.

In a group of compounds consisting of the amorphous oxides and the chalcogenides, amorphous oxides and chalcogenides of metalloid elements are more preferable, and oxides and chalcogenides formed of a single element or a combination of two or more elements selected from elements in Groups 13 (IIIB) to 15 (VB) of the periodic table, Al, Ga, Si, Sn, Ge, Pb, Sb, and Bi are still more preferable. Specifically, preferable examples of the amorphous oxides and chalcogenides include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₅, Bi₂O₃, Bi₂O₄, SnSiO₃, GeS, SnS, SnS₂, PbS, PbS₂, Sb₂S₃, Sb₂S₅, and SnSiS₃. In addition, composite oxides of these examples with lithium oxide, for example, Li₂SnO₂ may be used.

In the non-aqueous secondary cell according to the present invention, the average particle size of the negative electrode active material to be used is preferably 0.1 μm to 60 μm. In order to obtain the predetermined particle size, a well-known pulverizer or classifier is used. For example, a mortar, a ball mill, a sand mill, a vibration ball mill, a satellite ball mill, a planetary ball mill, a swirling air flow jet mill, or a sieve is preferably used. During the pulverization, wet pulverization of causing water or an organic solvent such as methanol to coexist with the negative electrode active material can be optionally performed. In order to obtain a desired particle size, it is possible to perform classification. A classification method is not particularly limited, and a method using, for example, a sieve or an air classifier can be optionally used. The classification can be used using a dry method or a wet method.

The chemical formula of the compound obtained using the calcination method can be obtained by using inductively coupled plasma (ICP) optical emission spectroscopy as a measurement method, or can be calculated from a mass difference of the powder before and after calcination as a short-cut method.

In the present invention, preferable examples of the negative electrode active material which can be used in combination with the amorphous oxide as negative electrode active material containing Sn, Si, or Ge as a major component include carbon materials that can store and release lithium ions or lithium metal; lithium; lithium alloys; and metals that can form an alloy with lithium.

As preferred embodiments, when being used in combination with both a high-potential negative electrode (preferably containing a lithium titanium oxide having a potential of 1.55 V vs. Li metal) and a low-potential negative electrode (preferably a carbon material having a potential of about 0.1 V vs. Li metal), the electrolytic solution according to the present invention can exhibit superior characteristics. The electrolytic solution according to the present invention can also be preferably used in a negative electrode formed of a metal or metal oxide which is capable of forming an alloy with lithium (preferably Si, a Si oxide, a Si/Si oxide, Sn, a Sn oxide, SₙBₓP_{y}O_{z}, Cu/Sn, and a complex of plural kinds thereof) and has been developed to realize high capacity; and a cell including a negative electrode formed of a complex of the metal or metal oxide with a carbon material.

In the present invention, lithium titanate, more specifically, lithium titanium oxide (Li[Li_{1/3}Ti_{5/3}]O₄) can be preferably used as the negative electrode active material. By using this material as a negative electrode active material, the effects of the electrolytic solution according to the present invention can be further improved, and further improved cell performance can be exhibited.

•Conductive Material

Any electron conductive materials can be used as the conductive material as long as they do not cause a chemical change in a constructed secondary cell, and a well-known conductive material can be arbitrarily used. Typically, one kind or a mixture of two or more kinds can be used among the following conductive materials including: natural graphite (for example, scale-like graphite, flaky graphite, or amorphous graphite), artificial graphite, carbon black, acetylene black, Ketjen black, carbon fibers, metal powders (for example, copper, nickel, aluminum, or silver (described in JP1988-10148A (JP-S63-10148A) and JP1988-554A (JP-S63-554A), metal fibers, and polyphenylene derivatives (described in JP1984-20A (JP-S59-20A) and JP1984-971A (JP-S59-971A). Among these, a combination of graphite and acetylene black is more preferable. The addition amount of the conductive material is preferably 1 mass % to 50 mass % and more preferably 2 mass % to 30 mass %. The addition amount of carbon or graphite is more preferably 2 mass % to 15 mass %.

•Binder

Examples of the binder include polysaccharides, thermoplastic resins, and polymers having rubber elasticity. Preferable examples of the binder include emulsions (latexes) or suspensions of water-soluble polymers (for example, starch, carboxymethyl cellulose, cellulose, diacetyl cellulose, methyl cellulose, hydroxyethyl cellulose, hydroxypropyl cellulose, sodium alginate, polyacrylic acid, sodium polyacrylate, polyvinyl phenol, polyvinyl methyl ether, polyvinyl alcohol, polyvinyl pyrrolidone, polyacrylonitrile, polyacrylamide, polyhydroxy (meth)acrylate, and a styrene-maleic acid copolymer), polyvinyl chloride, polytetrafluoroethylene, polyvinylidene fluoride, a tetrafluoroethylene-hexafluoropropylene copolymer, a vinylidene fluoride-tetrafluoroethylene-hexafluoropropylene copolymer, polyethylene, polypropylene, an ethylene-propylene-diene terpolymer (EPDM), a sulfonated EPDM, a polyvinyl acetal resin, (meth)acyrylic acid ester copolymers containing a (meth)acyrylic acid ester (for example, methyl methacrylate and 2-ethylhexyl acrylate), a (meth)acrylic acid ester-acrylonitrile copolymer, a polyvinyl ester copolymer containing a vinyl ester (for example, vinyl acetate), a styrene-butadiene copolymer, an acrylonitrile-butadiene copolymer, polybutadiene, a neoprene rubber, a fluorine rubber, poly(ethylene oxide), a polyester polyurethane resin, a polyether polyurethane resin, a polycarbonate polyurethane resin, a polyester resin, a phenolic resin, and an epoxy resin. More preferable examples of the binder include a polyacrylic acid ester latex, carboxymethyl cellulose, polytetrafluoroethylene, and polyvinylidene fluoride.

As the binder, one kind can be used alone, or a mixture of two or more kinds can be used. When the addition amount of the binder is excessively small, the holding force and cohesive force of the electrode mixture are weakened. When the addition amount of the binder is excessively great, the electrode volume increases, and thus the capacity per unit volume or unit mass of the electrode is decreased. Due to the above reasons, the addition amount of the binder is preferably 1 mass % to 30 mass % and more preferably 2 mass % to 10 mass %.

•Filler

The electrode mixture may contain a filler. As a material forming the filler, any fibrous materials can be used as long as they do not cause a chemical change in the secondary cell according to the present invention. Typically, fibrous fillers formed from olefin polymers such as polypropylene and polyethylene, and materials such as glass and carbon are used. The addition amount of the filler is not particularly limited and is preferably 0 mass % to 30 mass % in the dispersion.

•Current Collector

As the current collectors of the positive and negative electrodes, an electron conductor that does not cause a chemical change in the non-aqueous electrolyte secondary cell according to the present invention is used. As the current collector of the positive electrode, aluminum, stainless steel, nickel, titanium, or aluminum or stainless steel surface-treated with carbon, nickel, titanium, or silver is preferable. Among these, aluminum or an aluminum alloy is more preferable.

As the current collector of the negative electrode, aluminum, copper, stainless steel, nickel, or titanium is preferable, and aluminum, copper, or a copper alloy is more preferable.

Regarding the shape of the current collector, a film sheet-shaped current collector is usually used, but a net-shaped material, a material formed by punching, a lath material, a porous material, a foam, a material obtained by molding a group of fibers, and the like can also be used. The thickness of the current collector is not particularly limited but is preferably 1 μm to 500 μm. In addition, it is also preferable that the surface of the current collector is made to be uneven through a surface treatment.

The electrode mixture of the lithium secondary cell is formed of components which are appropriately selected from these materials.

(Separator)

The separator which can be used in the non-aqueous secondary cell according to the present invention is not particularly limited as long as it is formed of a material that electronically insulates the positive electrode and the negative electrode and has mechanical strength, ion permeability, and oxidation-reduction resistance at a contact surface between the positive electrode and the negative electrode. As such a material, for example, a porous polymer material, an inorganic material, an organic-inorganic hybrid material, or a glass fiber is used. In order to ensure safety, it is preferable that the separator has a shutdown function, that is, a function of interrupting the current by blocking pores at 80° C. or higher to increase resistance. The blocking temperature is preferably 90° C. to 180° C.

The shape of the pores of the separator is typically circular or elliptical, and the size thereof is 0.05 μm to 30 μm and preferably 0.1 μm to 20 μm. Further, the shape of the pores may be rod-like or indefinite as in a case where a separator is prepared using a drawing method or a phase separation method. An occupancy ratio of the pores, that is, a porosity is 20% to 90% and preferably 35% to 80%.

As the polymer material, a single material such as cellulose non-woven fabric, polyethylene, or polypropylene may be used alone, and a composite material of two or more kinds may be used. A laminate of two or more microporous films having different pore sizes, porosities, and pore blocking temperatures is preferable.

As the inorganic material, an oxide such as alumina or silicon dioxide, a nitride such as aluminum nitride or silicon nitride, or a sulfate such as barium sulfate or calcium sulfate is used, and the shape thereof is particulate or fibrous. The form of the inorganic material may be a thin film-shaped material such as a non-woven fabric, a woven fabric, or a microporous film. As the thin film-shaped material, a material having a pore size of 0.01 μm to 1 μm and a thickness of 5 μm to 50 μm is preferably used. In addition to the above-described independent thin film-shaped material, a separator in which a composite porous layer containing particles of the above-described inorganic material is formed on a surface layer of the positive electrode and/or the negative electrode using a binder formed of a resin can be used. For example, a porous layer containing alumina particles having a 90% particle size of less than 1 μm is formed on both surfaces of the positive electrode using a binder formed of a fluororesin.

Preparation of Non-Aqueous Secondary Cell

As described above, the non-aqueous secondary cell according to the present invention may have any shape such as a sheet shape, a square shape, or a cylindrical shape. In many cases, the current collector is coated with the mixture of the positive electrode active material or the negative electrode active material, is dried, and is compressed to be used.

Hereinafter, the configuration and preparation method of the bottomed cylindrical lithium secondary cell 100 will be described as an example with reference to FIG. 2. In a bottomed cylindrical cell, the outer surface area relative to a power generating element to be charged is reduced. Therefore, the cell preferably has a design in which Joule's heat generated due to internal resistance during charging or discharging is efficiently dissipated to the outside. In addition, the cell preferably has a design in which the packing ratio of a material having high thermal conductivity is improved so as to decrease an internal temperature distribution. FIG. 2 shows the bottomed cylindrical lithium secondary cell 100 as an example. In this bottomed cylindrical lithium secondary cell 100, a wound laminate where a positive electrode sheet 14 and a negative electrode sheet 16 are superimposed with a separator 12 interposed therebetween is accommodated in an outer can 18. In the drawing, reference numeral 20 represents an insulating plate, reference numeral 22 represents a sealing plate, reference numeral 24 represents a positive electrode current collector, reference numeral 26 represents a gasket, reference numeral 28 represents a pressure-sensitive valve, and reference numeral 30 represents a current interrupting element. In an enlarged circle, a hatched portion is different from that of the overall diagram in consideration of visibility, but the respective components represented by reference numerals corresponds to those in the overall diagram.

First, the negative electrode mixture and various additives including the binder, the filler, and the like which are optionally used are dissolved in an organic solvent to obtain a mixture. As a result, a slurry or paste negative electrode mixture can be prepared. The entire region of both surfaces of a metal core as a current collector is uniformly coated with the obtained negative electrode mixture. Next, the organic solvent is removed, and a negative electrode mixture layer is formed. Further, the laminate of the current collector and the negative electrode mixture layer is rolled using a roll press machine. As a result, a negative electrode sheet (electrode sheet) having a predetermined thickness is prepared. At this time, conventional methods can be used as the coating method of the respective materials, the drying method of the coated material, and the forming method of the positive and negative electrodes.

In the embodiment, the cylindrical cell has been described as an example, but the present invention is not limited thereto. For example, after the positive and negative electrode sheets prepared using the above-described method are superimposed with the separator interposed therebetween, the laminate may be processed into a sheet-shaped cell as it is. Alternatively, the laminate may be folded and inserted into a square can so as to electrically connect the can and the sheet to each other, and then an electrolyte is injected thereto, and an opening is sealed using the sealing plate, thereby forming a square cell.

In all the embodiments, a safety valve can be used as the sealing plate for sealing the opening. In addition, as a sealing component, various well-known safety elements of the related art may be provided in addition to the safety valve. For example, as an overcurrent preventing element, for example, a fuse, a bimetal, or a PTC element is preferably used.

In addition, in addition to the safety valve, as a countermeasure against an increase in the internal pressure of the cell can, a method of forming a slit in the cell can, a gasket cracking method, or a sealing plate cracking method, or a method of disconnecting a lead plate can be used. In addition, a protective circuit into which an overcharge or overdischarge preventing mechanism is embedded is provided to a charger or is separately connected to a charger.

As the can or the lead plate, an electrically conductive metal or alloy can be used. For example, a metal such as iron, nickel, titanium, chromium, molybdenum, copper or aluminum or an alloy thereof is preferably used.

As a welding method of a cap, a can, a sheet, or a lead plate, a well-known method (for example, DC or AC electric welding, laser welding, or ultrasonic welding) can be used. As a sealing agent for sealing the opening, a well-known compound of the related art such as asphalt or a mixture can be used.

[Electrode Potential and Resistance Increase Rate]

In the electrolytic solution or the secondary cell according to the present invention, it is preferable that the specific compound does not function at a normal charging positive electrode potential or lower. Specifically, the normal charging positive electrode potential of the cell (the positive electrode potential of the positive electrode active material) is preferably 4.25 V or higher (vs. Li/Li⁺) and more preferably 4.3 V or higher. The upper limit of the positive electrode potential is not particularly limited, but is practically 5 V or lower. Further, a resistance increase rate is preferably 5 or more and more preferably 15 or more which is calculated by impedance measurement according to the following expression. The upper limit of the resistance increase rate is not particularly limited, but is preferably 1000 or less.

[Method of Measuring Resistance Increase Rate]

As a method of measuring the resistance of the cell, for example, a method of measuring the AC impedance of the cell is used. The resistance of the cell can be measured from a graph called “Cole-Cole Plot” which is obtained by plotting a change in impedance on a complex plane while changing the frequency from a low frequency to a high frequency. The resistance increase rate can be obtained from a resistance during overcharge and a resistance at a normal potential. The details of the measurement method can refer to a method adopted in Examples.

The meanings of the terms described herein will be described below. “Normal charging” refers to a state where charging is performed at a design voltage of the cell. For example, in a constant current-constant voltage charging method which is generally used, a cell is charged to a setting voltage at a constant current and then is charged in a state where the setting voltage is kept until the cell is fully charged. “The positive electrode potential during normal charging” described refers to the positive electrode potential at the setting voltage. On the other hand, “overcharge” refers to a state where a cell is charged at a voltage exceeding the setting voltage of the cell due to some factors.

[Use of Non-Aqueous Secondary Cell]

The non-aqueous secondary cell according to the present invention having superior cycle characteristics can be prepared and is applied to various uses.

The application embodiment is not particularly limited, and examples of an electronic apparatus to which the non-aqueous secondary cell is applied include a laptop computer, a pen-input PC, a mobile PC, an electronic book player, a mobile phone, a cord-less phone system, a pager, a handy terminal, a portable fax, a portable copying machine, a portable printer, a headphone stereo set, a video camera, a liquid crystal television, a handy cleaner, a portable CD player, a mini disc player, an electric shaver, a transceiver, an electronic organizer, an electronic calculator, a portable tape recorder, a radio player, a backup power supply, and a memory card. In addition, examples of an electronic apparatus for consumer use include an automobile, an electromotive vehicle, a motor, a lighting device, a toy, a game device, a load conditioner, a timepiece, a strobe, a camera, a medical device (for example, a pacemaker, a hearing aid, or a shoulder massager). Further, the non-aqueous secondary cell can be used as various cells for use in military or aerospace applications. In addition, the non-aqueous secondary cell can be used in combination with a solar cell.

The application embodiment of the electrolytic solution for a non-aqueous secondary cell according to the present invention is not particularly limited. In particular, from the viewpoint of exhibiting the advantageous effects including the safety during overcharge and the high-rate discharging characteristics, the electrolytic solution for a non-aqueous secondary cell according to the present invention is preferably used in an application where high-capacity and high-rate discharging characteristics are required. For example, in the future, in electric storage equipment where high capacity is expected to be used, high safety is essential, and high cell performance is also required. In addition, an application is assumed in which, when being mounted on an electric vehicle or the like, a high-capacity secondary cell is charged every day at home. In this application, higher safety is required during overcharge. (“NEDO Road Map 2008 of Storage Cell Technology Development for Next-Generation Vehicles”, Storage Cell Technique Development, Fuel Cell and Hydrogen Technology Development Department, New Energy and Industrial Technology Development Organization (July, 2009)). In addition, high-rate discharging is necessary during departure and acceleration, and it is important to prevent the high-rate discharge capacity from deteriorating even during repeated charging and discharging. In such a usage environment, the non-aqueous secondary cell according to the present invention can be suitably used and can exhibit the superior effects.

### EXAMPLES

### Example 1 and Comparative Example 1

### Preparation of Electrolytic Solution for Cell (1)

(A) Components were added to a solvent shown in Table 1 in an amount shown in the table, subsequently, LiPF₆ or LiBF₄ as an electrolyte was dissolved therein so as to be 1 M. As a result, each electrolytic solution for a test was prepared. The viscosity of the prepared electrolytic solution at 25° C. was 5 mPa·s or less, and the water content measured using a Karl-Fischer method (JIS K 0113) was 20 ppm or less. The compounds used in the table are as follows.

<Preparation of Cell (1)>

A positive electrode was prepared using an electrode mixture including: 85 mass % of lithium nickel manganese cobalt oxide (LiNi_{1/3}Mn_{1/3}CO_{1/3}O₂) as an active material; 7 mass % of carbon black as a conductive auxiliary agent; and 8 mass % of PVDF as a binder. A negative electrode was prepared using an electrode mixture including: 94 mass % of lithium titanium oxide (Li₄Ti₅O₁₂) as an active material; 3 mass % of carbon black as a conductive auxiliary agent; and 3 mass % of PVDF as a binder. A separator was formed of cellulose, and the thickness thereof was 50 μm. Using the positive and negative electrodes and the separator, a 2032-type coin cell was prepared for each electrolytic solution for a test and was initialized by the following conditions.

<Initialization of Cell>

In a thermostatic chamber at 30° C., the 2032-type cell was charged to a cell voltage of 2.55 V (a positive electrode potential of 4.1 V) at a constant current at 0.2 C. Next, the cell was charged to a current value of 0.12 mA at a constant voltage (cell voltage) of 2.55 V. However, the upper limit of the charging time was set as 2 hours. Next, in a thermostatic chamber at 30° C., the cell was discharged to a cell voltage of 1.2 V at a constant current at 0.2 C. This operation was repeated two times. The lithium titanium oxide negative electrode has an action potential of 1.55 V. Therefore, the cell voltage was a value obtained by subtracting 1.55 V from the positive electrode potential. Using the 2032-type cell prepared using the above method, the following items were evaluated. The results are shown in Table 1.

<Overcharge Test>

In a thermostatic chamber at 30° C., as a normal potential test, the 2032-type cell prepared using the above method was charged to a positive electrode potential of 4.1 V at a constant current of 2 mA (1 C) and then was discharged at a constant voltage for 2 hours. The resistance of the cell was measured by impedance measurement. Next, as an overcharge test, the cell was charged to a positive electrode potential of 5 V at a constant current of 2 mA (1 C). Next, the cell was charged at a constant voltage for 2 hours, and the resistance was measured by impedance measurement. As a result, a resistance increase rate during overcharge was calculated from the following expression. A large value of the resistance increase rate represents that an increase in resistance during overcharge can be increased, and an excessive release of lithium ions from the positive electrode can be suppressed.

Resistance Increase Rate=(Resistance at 5 V/Resistance at 4.1 V)

The results of the resistance increase rate of the overcharge test were evaluated as follows.

AA: 20 or higher
A: 15 to lower than 20
B: 5 to lower than 15
C: 5 or lower

<Cell Performance Deterioration Test During Normal Use>

Using the following method, a deterioration in cell performance during normal use was tested when the cell was used at a positive electrode potential shown in the table.

<Discharge Capacity Retention Ratio at 4.1 V>

<Initial 4 C Discharge Capacity at 4.1 V>

In a thermostatic chamber at 45° C., the initialized cell was charged to a cell voltage of 2.55 V (a positive electrode potential of 4.1 V) at a constant current at 0.2 C. Next, the cell was charged to a current value of 0.12 mA at a constant voltage of 2.55 V. However, the upper limit of the charging time was set as 2 hours. Next, in a thermostatic chamber at 45° C., the cell was discharged to a cell voltage of 1.2 V at a constant current at 4 C. As a result, an initial discharge capacity (I) at a positive electrode potential of 4.1 V was measured.

<Discharge Capacity at 4.1 V after Cycle Test>

In a thermostatic chamber at 45° C., the cell was charged to a cell voltage of 2.55 V (a positive electrode potential of 4.1 V) at a constant current at 1 C. Next, the cell was charged to a current value of 0.12 mA at a constant voltage of 2.55 V. However, the upper limit of the charging time was set as 2 hours. Next, the cell was discharged at a constant current at 1 C until the cell voltage reached 1.2 V. These operations were set as one cycle. These operations were repeated in 200 cycles. Next, a 4 C discharge capacity (II) was measured using the same measurement method as that of the initial 4 C discharge capacity (I). The discharge capacity retention ratio (4.1 V) before and after the cycle test was calculated from the following expression. A large value represents that, even when a cell is repeatedly charged and discharged, deterioration in capacity during large current discharging (4 C) is low and excellent.

Discharge Capacity Retention Ratio (4.1 V)=(II)/(I)

<4 C Discharge Capacity Retention Ratio at 4.3 V>

The same test as that of the measurement of the 4 C discharge capacity at 4.1 V was performed, except that the cell voltage during charging was changed to 2.7 V (positive electrode potential was changed to 4.3 V). Next, an initial 4 C discharge capacity (III) at 4.3 V and a 4 C discharge capacity (IV) at 4.3 V after the cycle test were measured. The discharge capacity retention ratio (4.3 V) before and after the cycle test was calculated from the following expression. A large value represents that, even when a cell is repeatedly charged and discharged, deterioration in capacity during large current discharging (4 C) is low and excellent.

Discharge Capacity Retention Ratio (4.3 V)=(IV)/(III)

When a higher cell voltage (positive electrode potential) was used, it is preferable that the capacity retention ratio increases because the cell capacity increases.

The results of the discharge capacity retention ratio were evaluated as follows.

AA: 0.9 or higher
A: 0.8 to lower than 0.9
B: 0.7 to lower than 0.8
C: 0.5 to lower than 0.7
D: lower than 0.5

TABLE 1

| | | | | | | | | | | | | Discharge | |
|---|---|---|---|---|---|---|---|---|---|---|---|---|---|
| | | | | | | | | | | | | Capacity | |
| | | | Solvent | | | | | | Other | | | Retention | |
| | Compound (A) | | Carbonate Compound (B) | | | | Other Solvents | | components | | Resistance Increase | Ratio | |
| Test No. | Comp. | Conc.*1 | Comp. | Conc.*2 | Comp. | Conc.*2 | Comp. | Conc.*2 | Comp. | Conc.*1 | Rate | 4.1 V | 4.3 V |
| 101 | I-1 | 1 | EC | 33 | EMC | 67 | | | | | A | A | B |
| 102 | I-3 | 1 | EC | 33 | EMC | 67 | | | | | A | A | B |
| 103 | I-6 | 1 | EC | 33 | EMC | 67 | | | | | A | A | B |
| 104 | I-8 | 1 | EC | 33 | EMC | 67 | | | | | A | A | B |
| 105 | I-12 | 1 | EC | 33 | EMC | 67 | | | | | A | A | B |
| 106 | I-13 | 1 | EC | 33 | EMC | 67 | | | | | A | A | B |
| 107 | I-15 | 1 | EC | 33 | EMC | 67 | | | | | AA | A | B |
| 108 | I-17 | 1 | EC | 33 | EMC | 67 | | | | | AA | AA | AA |
| 109 | I-29 | 1 | EC | 33 | EMC | 67 | | | | | AA | AA | A |
| 110 | I-19 | 1 | EC | 33 | EMC | 67 | | | | | AA | AA | A |
| 111 | I-20 | 1 | EC | 33 | EMC | 67 | | | | | AA | AA | AA |
| 112 | I-22 | 1 | EC | 33 | EMC | 67 | | | | | AA | AA | AA |
| 113 | I-1 | 1 | EC | 33 | EMC | 67 | | | J-3 | 1 | A | A | A |
| 114 | I-3 | 1 | EC | 33 | EMC | 67 | | | J-4 | 1 | A | A | B |
| 115 | I-6 | 1 | EC | 33 | EMC | 67 | | | J-5 | 1 | A | A | A |
| 116 | I-8 | 1 | EC | 33 | EMC | 67 | | | J-3 | 1 | AA | A | A |
| 117 | I-12 | 1 | EC | 33 | EMC | 67 | | | J-6 | 1 | A | A | B |
| 118 | I-13 | 1 | EC | 33 | EMC | 67 | | | J-7 | 1 | A | A | B |
| 119 | I-15 | 1 | EC | 33 | EMC | 67 | | | J-3 | 1 | AA | A | AA |
| 120 | I-17 | 1 | EC | 33 | EMC | 67 | | | J-5 | 1 | AA | AA | AA |
| 121 | I-18 | 1 | EC | 33 | EMC | 67 | | | J-3 | 1 | AA | AA | AA |
| 122 | I-19 | 1 | EC | 33 | EMC | 67 | | | J-5 | 1 | AA | AA | AA |
| 123 | I-20 | 1 | EC | 33 | EMC | 39 | PC | 28 | J-3 | 1 | AA | AA | AA |
| 124 | I-22 | 1 | EC | 33 | EMC | 39 | PC | 28 | J-4 | 1 | AA | AA | AA |
| 125 | I-20 | 1 | EC | 33 | EMC | 39 | PC | 28 | | | AA | AA | AA |
| 126 | I-20 | 1 | EC | 33 | EMC | 39 | PC | 28 | J-3 | 1 | AA | AA | AA |
| c201 | | | EC | 33 | EMC | 67 | | | | | C | C | D |
| c202 | J-1 | 1 | EC | 33 | EMC | 67 | | | | | C | D | D |
| c203 | J-2 | 1 | EC | 33 | EMC | 67 | | | | | C | D | D |
| c204 | J-3 | 3 | EC | 33 | EMC | 67 | | | J-3 | 1 | B | D | D |

Test No.: Examples starting with “c” are Comparative Examples, and other examples are examples according to the present invention.

Comp: Exemplary No. of the compound
Conc*1: mass % with respect to the total amount of the electrolytic solution
Conc*2: vol % with respect to the total amount of the solvent
EC: Ethylene carbonate
EMC: Ethyl methyl carbonate

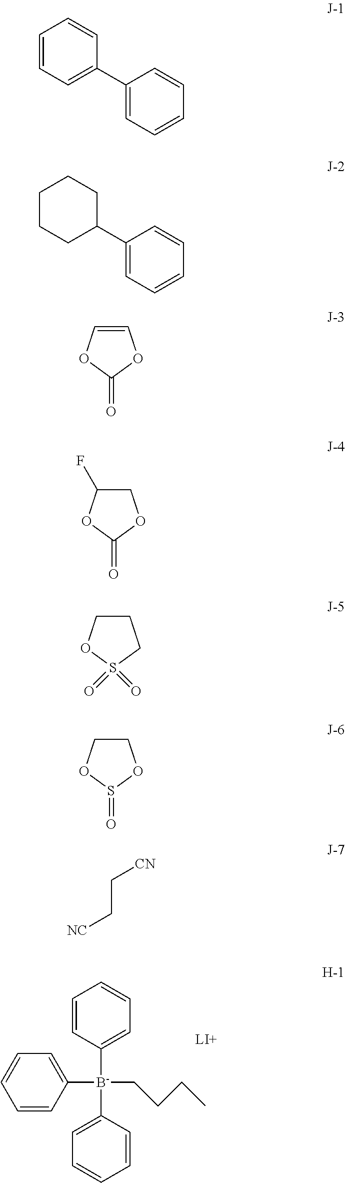

### Example 2 and Comparative Example 2

### Preparation of Electrolytic Solution

Compound (A) was dissolved in a 1M-LiPF₆ solution using a solution shown in Table 2 in a concentration shown in the table. An electrolytic solution for an example and an electrolytic solution for a comparative example were prepared. The viscosity of the prepared electrolytic solution at 25° C. was 5 mPa·s or less.

<Preparation of Cell (2)>

A positive electrode was prepared using an electrode mixture including: 85 mass % of lithium manganese oxide (LiMn₂O₄) as an active material; 7 mass % of carbon black as a conductive auxiliary agent; and 8 mass % of PVDF as a binder. A negative electrode was prepared using an electrode mixture including: 86 mass % of graphite as an active material; 6 mass % of carbon black as a conductive auxiliary agent; and 8 mass % of PVDF as a binder. A separator was formed of polypropylene, and the thickness thereof was 25 μm. Using the positive and negative electrodes and the separator, a 2032-type coin cell was prepared for the electrolytic solution for each Test No. and was evaluated for the following items. The results are shown in Table 2.

<Initialization of Cell>

In a thermostatic chamber at 30° C., the 2032-type cell was charged to a positive electrode potential of 4.1 V at a constant current at 0.2 C. Next, the cell was charged to a current value of 0.12 mA at a constant voltage (positive electrode potential) of 4.1 V. However, the upper limit of the charging time was set as 2 hours. Next, in a thermostatic chamber at 30° C., the cell was discharged to a cell voltage of 2.75 V at a constant current at 0.2 C. This operation was repeated two times.

Using the 2032-type cell prepared using the above method, the following items were evaluated. The results are shown in Table 2.

<Overcharge Test>

In a thermostatic chamber at 30° C., as a normal potential test, the 2032-type cell prepared using the above method was charged to a positive electrode potential of 4.1 V at a constant current of 2 mA (1 C) and then was discharged at a constant voltage for 2 hours. The resistance of the cell was measured by impedance measurement. Next, as an overcharge test, the cell was charged to a positive electrode potential of 5 V at a constant current of 2 mA (1 C). Next, the cell was charged at a constant voltage for 2 hours, and the resistance was measured by impedance measurement. As a result, a resistance increase rate during overcharge was calculated from the following expression. A large value of the resistance increase rate represents that an increase in resistance during overcharge can be increased, and an excessive release of lithium ions from the positive electrode can be suppressed.

Resistance Increase Rate=(Resistance at 5 V/Resistance at 4.1 V)

The results of the resistance increase rate of the overcharge test were evaluated as follows.

AA: 20 or higher
A: 15 to lower than 20
B: 5 to lower than 15
C: 5 or lower

<Cell Performance Deterioration Test During Normal Use>

Using the following method, a deterioration in cell performance during normal use was tested when the cell was used at a positive electrode potential shown in the table.

<4 C Discharge Capacity Retention Ratio at 4.1 V>

<Initial 4 C Discharge Capacity at 4.1 V>

In a thermostatic chamber at 30° C., the initialized cell was charged to a positive electrode potential of 4.1 V at a constant current at 0.2 C. Next, the cell was charged to a current value of 0.12 mA at a constant voltage of 4.1 V. However, the upper limit of the charging time was set as 2 hours. Next, in a thermostatic chamber at 30° C., the cell was discharged to a cell voltage of 2.75 V at a constant current at 4 C. As a result, an initial 4 C discharge capacity (V) at 4.1 V was measured.

<4 C Discharge Capacity at 4.1 V after Cycle Test>

In a thermostatic chamber at 30° C., the cell was charged to a positive electrode potential of 4.1 V at a constant current at 1 C. Next, the cell was charged to a current value of 0.12 mA at a constant voltage of 4.1 V. However, the upper limit of the charging time was set as 2 hours. Next, the cell was discharged at a constant current at 1 C until the cell voltage reached 2.75 V. These operations were set as one cycle. These operations were repeated in 300 cycles. Next, a 4 C discharge capacity (VI) at 4.1 V was measured using the same measurement method as that of the initial 4 C discharge capacity (V). The discharge capacity retention ratio (4.1 V) before and after the cycle test was calculated from the following expression. A large value represents that, even when a cell is repeatedly charged and discharged, deterioration in capacity during large current discharging (4 C) is low and excellent.

Discharge Capacity Retention Ratio (4.1 V)=(VI)/(V)

<4 C Discharge Capacity Retention Ratio at 4.3 V>

The same test as that of the measurement of the 4 C discharge capacity at 4.1 V was performed, except that the positive electrode potential during charging was changed to 4.3 V. Next, an initial 4 C discharge capacity (VII) at 4.3 V and a 4 C discharge capacity (VIII) at 4.3 V after the cycle test were measured. The discharge capacity retention ratio (4.3 V) before and after the cycle test was calculated from the following expression. A large value represents that, even when a cell is repeatedly charged and discharged, deterioration in capacity during large current discharging (4 C) is low and excellent.

Discharge Capacity Retention Ratio (4.3 V)=(VIII)/(VII)

The results of the discharge capacity retention ratio were evaluated as follows.

AA: 0.9 or higher
A: 0.8 to lower than 0.9
B: 0.7 to lower than 0.8
C: 0.5 to lower than 0.7
D: lower than 0.5

TABLE 2-1

| | | | | | | | | | | | | Discharge | |
|---|---|---|---|---|---|---|---|---|---|---|---|---|---|
| | | | | | | | | | | | | Capacity | |
| | | | Solvent | | | | | | Other | | | Retention | |
| | Compound (A) | | Carbonate Compound (B) | | | | Other Solvents | | components | | Resistance Increase | Ratio | |
| Test No. | Comp. | Conc.*1 | Comp. | Conc.*2 | Comp. | Conc.*2 | Comp. | Conc.*2 | Comp. | Conc.*1 | Rate | 4.1 V | 4.3 V |
| 201 | I-1 | 1 | EC | 33 | EMC | 67 | | | | | A | B | C |
| 202 | I-3 | 1 | EC | 33 | EMC | 67 | | | | | A | A | B |
| 203 | I-6 | 1 | EC | 33 | EMC | 67 | | | | | A | B | C |
| 204 | I-8 | 1 | EC | 33 | EMC | 67 | | | | | A | A | B |
| 205 | I-12 | 1 | EC | 33 | EMC | 67 | | | | | A | B | B |
| 206 | I-13 | 1 | EC | 33 | EMC | 67 | | | | | A | AA | A |
| 207 | I-15 | 1 | EC | 33 | EMC | 67 | | | | | AA | B | B |
| 208 | I-16 | 1 | EC | 33 | EMC | 67 | | | | | AA | A | A |
| 209 | I-29 | 1 | EC | 33 | EMC | 67 | | | | | AA | A | A |
| 210 | I-19 | 1 | EC | 33 | EMC | 67 | | | | | AA | A | A |
| 211 | I-20 | 1 | EC | 33 | EMC | 67 | | | | | AA | AA | A |
| 212 | I-22 | 1 | EC | 33 | EMC | 67 | | | | | AA | A | A |
| 213 | I-29 | 1 | EC | 33 | EMC | 67 | | | | | A | AA | AA |
| 214 | I-34 | 1 | EC | 33 | EMC | 67 | | | | | AA | AA | AA |
| 215 | I-1 | 1 | EC | 33 | EMC | 67 | | | J-3 | 1 | A | A | B |
| 216 | I-3 | 1 | EC | 33 | EMC | 67 | | | J-4 | 1 | A | A | AA |
| 217 | I-6 | 1 | EC | 33 | EMC | 67 | | | J-5 | 1 | A | B | B |
| 218 | I-8 | 1 | EC | 33 | EMC | 67 | | | J-3 | 1 | AA | A | A |
| 219 | I-12 | 1 | EC | 33 | EMC | 67 | | | J-6 | 1 | A | A | B |
| 220 | I-13 | 1 | EC | 33 | EMC | 67 | | | J-7 | 1 | A | AA | A |
| 221 | I-15 | 1 | EC | 33 | EMC | 67 | | | J-3 | 1 | AA | A | B |
| 222 | I-16 | 1 | EC | 33 | EMC | 67 | | | J-5 | 1 | AA | AA | A |
| 223 | I-18 | 1 | EC | 33 | EMC | 67 | | | J-3 | 1 | AA | AA | A |
| 224 | I-19 | 1 | EC | 33 | EMC | 67 | | | J-5 | 1 | AA | AA | A |
| 225 | I-20 | 1 | EC | 33 | EMC | 39 | PC | 28 | J-3 | 1 | AA | AA | AA |
| 226 | I-22 | 1 | EC | 33 | EMC | 39 | PC | 28 | J-4 | 1 | AA | AA | A |
| 227 | I-20 | 1 | EC | 33 | EMC | 39 | PC | 28 | | | AA | AA | AA |
| 228 | I-20 | 1 | EC | 33 | EMC | 39 | PC | 28 | J-3 | 1 | AA | AA | AA |
| 229 | I-16 | 3 | EC | 33 | EMC | 67 | | | | | AA | A | A |
| 230 | I-16 | 0.5 | EC | 33 | EMC | 67 | | | | | A | AA | A |

TABLE 2-2

| | | | | | | | | | | | | Discharge | |
|---|---|---|---|---|---|---|---|---|---|---|---|---|---|
| | | | | | | | | | | | | Capacity | |
| | | | Solvent | | | | | | Other | | | Retention | |
| | Compound (A) | | Carbonate Compound (B) | | | | Other Solvents | | components | | Resistance Increase | Ratio | |
| Test No. | Comp. | Conc.*1 | Comp. | Conc.*2 | Comp. | Conc.*2 | Comp. | Conc.*2 | Comp. | Conc.*1 | Rate | 4.1 V | 4.3 V |
| 231 | I-20 | 3 | EC | 33 | EMC | 67 | | | | | AA | AA | A |
| 232 | I-20 | 0.5 | EC | 33 | EMC | 67 | | | | | AA | A | A |
| c201 | | | EC | 33 | EMC | 67 | | | | | C | C | D |
| c202 | J-1 | 1 | EC | 33 | EMC | 67 | | | | | C | D | D |
| c203 | J-2 | 1 | EC | 33 | EMC | 67 | | | | | C | D | D |
| c204 | J-2 | 3 | EC | 33 | EMC | 67 | | | J-3 | 1 | B | D | D |
| c205 | H-1 | 1 | EC | 33 | EMC | 67 | | | | | C | B | C |

Test No.: Examples starting with “c” are Comparative Examples, and other examples are examples according to the present invention.

Comp: Exemplary No. of the compound
Conc*1: mass % with respect to the total amount of the electrolytic solution
Conc*2: vol % with respect to the total amount of the solvent

It can be seen from the results of the above-described Examples that, according to the electrolytic solution of the present invention, even when the positive electrode is used under high-potential normal use conditions, high overcharge preventing ability and superior deterioration suppressing ability are exhibited, and superior cell characteristics are exhibited.

The same test as that of Test No. 101 was performed, except that one of Compounds I-5, I-25 to I-28, and I-30 was used instead of Compound I-1. As a result, the resistance increase rate was evaluated as “A”, and the discharge capacity retention ratio was evaluated as “B” or higher.

The present invention has been described using the embodiments. However, unless specified otherwise, any of the details of the above description is not intended to limit the present invention and can be construed in a broad sense within a range not departing from the concept and scope of the present invention disclosed in the accompanying claims.

What is claimed is:

1. An electrolytic solution for a non-aqueous secondary cell, comprising, in an organic solvent:
an electrolyte; and
an organic boron compound having at least one nitrogen-boron bond or an organic aluminum compound having at least one nitrogen-aluminum bond.

2. The electrolytic solution for a non-aqueous secondary cell according to claim 1,
wherein the organic boron compound or the organic aluminum compound contains a hetero ring having plural heteroatoms selected from nitrogen, oxygen, sulfur, and phosphorus.

3. The electrolytic solution for a non-aqueous secondary cell according to claim 1,
wherein the organic boron compound or the organic aluminum compound contains a hetero ring having plural nitrogen atoms.

4. The electrolytic solution for a non-aqueous secondary cell according to claim 1,
wherein the organic boron compound or the organic aluminum compound contains a hetero ring having a nitrogen-nitrogen bond.

5. The electrolytic solution for a non-aqueous secondary cell according to claim 1,
wherein the organic boron compound or the organic aluminum compound contains a 5-membered hetero ring.

6. The electrolytic solution for a non-aqueous secondary cell according to claim 1,
wherein the organic boron compound or the organic aluminum compound contains a hetero ring having pyrazole or triazole in a structure thereof.

7. The electrolytic solution for a non-aqueous secondary cell according to claim 1,
wherein the organic boron compound or the organic aluminum compound contains a structural unit represented by the following formula (1), 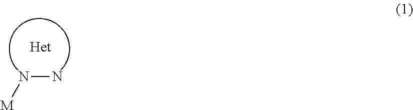
where M represents a boron atom or an aluminum atom; and Het represents a 5-membered or 6-membered hetero ring having a N—N bond.

8. The electrolytic solution for a non-aqueous secondary cell according to claim 7,
wherein a compound having the structural unit represented by the formula (1) is a compound represented by the following formula (I) or (II), 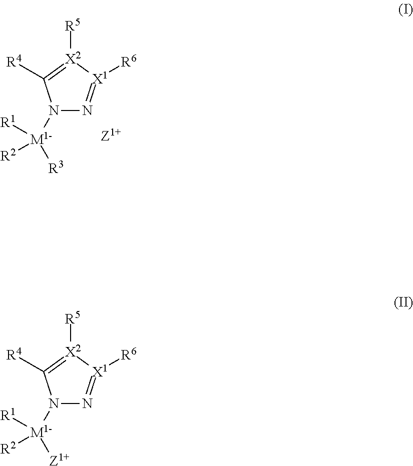
where R¹ to R³ each independently represents a halogen atom, an amino group, a silyl group, an alkoxy group, an aryloxy group, an acyloxy group, a heteroaryloxy group, a sulfonyloxy group-containing group, an alkyl group, an aryl group, or a heteroaryl group; R¹ to R³ may be bonded or condensed to each other to form a ring structure; R⁴ to R⁶ each independently represents a hydrogen atom, an alkyl group, an alkoxy group, a halogen atom, an acyloxy group, an alkoxycarbonyl group, a cyano group, an amino group, a silyl group, an aryl group, or a heteroaryl group; R⁴ to R⁶ may be respectively bonded or condensed to each other to form a ring structure; R¹ to R⁶ may be bonded to N or C on a ring to form a ring structure, in which an inorganic element may be interposed therebetween to form a ring, and a double bond on the ring may be a single bond; M¹ represents a boron atom or an aluminum atom; Z¹⁺ represents an inorganic or organic cation; X¹ and X² each independently represents a carbon atom or a nitrogen atom; and when X¹ and X² represent a nitrogen atom, R⁵ and R⁶ are not present.

9. The electrolytic solution for a non-aqueous secondary cell according to claim 8,
wherein the formula (II) is represented by the following formula (III) or (IV), 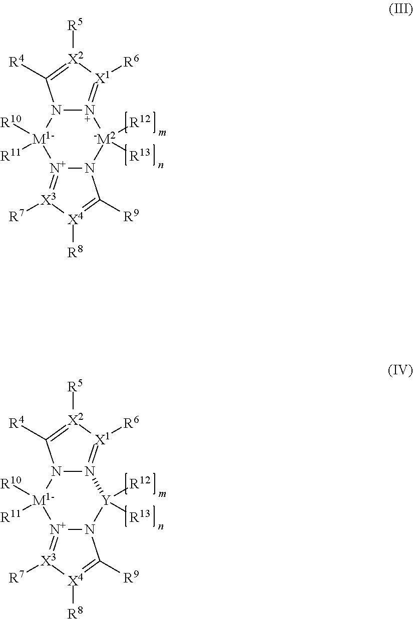
where R¹⁰ to R¹³ each independently represents a halogen atom, an alkoxy group, an aryloxy group, an acyloxy group, a heteroaryloxy group, a sulfonyloxy group-containing group, an alkyl group, an aryl group, or a heteroaryl group and may be respectively bonded or condensed to each other to form a ring structure; m and n represent an integer satisfying 0≦m+n≦3, R⁴ to R⁶ have the same definitions as in the formula (II); R⁷ to R⁹ have the same definitions as R⁴ to R⁶ in the formula (II); M¹ and M² represent a boron atom or an aluminum atom; Y represents a metal atom other than a boron atom and an aluminum atom; and X¹ to X⁴ each independently represents a carbon atom or a nitrogen atom, in which when X¹ to X⁴ represent a nitrogen atom, R⁵ to R⁸ are not present.

10. The electrolytic solution for a non-aqueous secondary cell according to claim 9,
wherein the formula (III) is represented by the following formula (V) or (VI), 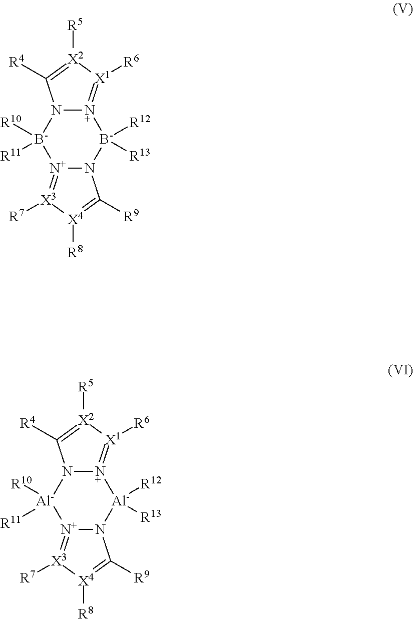
where R⁴ to R¹³ and X¹ to X⁴ have the same definitions as in the formula (III).

11. The electrolytic solution for a non-aqueous secondary cell according to claim 1, further comprising:
at least one compound selected from an aromatic compound (A), a halogen-containing compound (B), a polymerizable compound (C), a phosphorus-containing compound (D), a sulfur-containing compound (E), a silicon-containing compound (F), a nitrile compound (G), a metal complex compound (H), and an imide compound (I).

12. The electrolytic solution for a non-aqueous secondary cell according to claim 1,
wherein the content of the organic boron compound or the organic aluminum compound is 0.001 mass % to 10 mass %.

13. A non-aqueous secondary cell comprising:
a positive electrode;
a negative electrode; and
the electrolytic solution for a non-aqueous secondary cell according to claim 1.

14. The non-aqueous secondary cell according to claim 13,
wherein the positive electrode contains an active material,
the active material is a transition metal oxide capable of storing and releasing alkali metal ions.

15. The non-aqueous secondary cell according to claim 14,
wherein the active material contains a transition metal oxide represented by any one of the following formulae (MA) to (MC):
LiₐM¹O_{b} (MA);
Li_{c}M²₂O_{d} (MB); and
LiₑM³(PO₄)_{f} (MC),
where M¹ and M² each independently represents one or more elements selected from Co, Ni, Fe, Mn, Cu, and V; M³ represents one or more elements selected from V, Ti, Cr, Mn, Fe, Co, Ni, and Cu; a portion of M¹ to M³ may be substituted with at least one selected from elements other than lithium in Group 1 (Ia) of the periodic table, elements in Group 2 (IIa) of the periodic table, Al, Ga, In, Ge, Sn, Pb, Sb, Bi, Si, P, and B; a represents 0 to 1.2; b represents 1 to 3; c represents 0 to 2; d represents 3 to 5; e represents 0 to 2; and f represents 1 to 5.

16. The non-aqueous secondary cell according to claim 15,
wherein an active material of the positive electrode is lithium cobalt oxide, lithium manganese oxide, lithium nickel oxide, lithium nickel manganese cobalt oxide, lithium manganese nickel oxide, lithium nickel cobalt aluminum oxide, or lithium iron phosphate.

17. The non-aqueous secondary cell according to claim 13,
wherein the negative electrode contains an active material,
lithium titanium oxide or a carbon material is used as the active material of the negative electrode.

18. The non-aqueous secondary cell according to claim 13,
wherein a normal charging positive electrode potential of the cell is 4.25 V or higher vs. Li/Li⁺.

19. The non-aqueous secondary cell according to claim 13,
wherein a resistance increase rate is 5 or more which is calculated by impedance measurement according to the following expression:
Resistance Increase Rate=(Resistance after Charging to Positive Electrode Potential of 5 V)/(Resistance after Charging to Positive Electrode Potential of 4.1 V)

20. An additive for an electrolytic solution consisting of:
an organic boron compound having at least one nitrogen-boron bond or an organic aluminum compound having at least one nitrogen-aluminum bond.

21. The additive for an electrolytic solution according to claim 20,
wherein the organic boron compound or the organic aluminum compound is represented by the following formula (I) or (II), 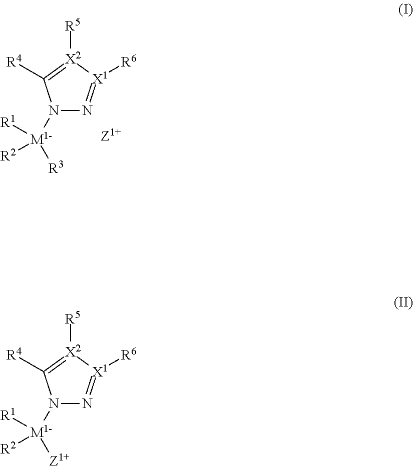
where R¹ to R³ each independently represents a halogen atom, an amino group, a silyl group, an alkoxy group, an aryloxy group, an acyloxy group, a heteroaryloxy group, a sulfonyloxy group-containing group, an alkyl group, an aryl group, or a heteroaryl group; R¹ to R³ may be respectively bonded or condensed to each other to form a ring structure; R⁴ to R⁶ each independently represents a hydrogen atom, an alkyl group, an alkoxy group, a halogen atom, an acyloxy group, an alkoxycarbonyl group, a cyano group, an amino group, a silyl group, an aryl group, or a heteroaryl group; R⁴ to R⁶ may be respectively bonded or condensed to each other to form a ring structure; R¹ to R⁶ may be bonded to N or C on a ring to form a ring structure, in which an inorganic element may be interposed therebetween to form a ring, and a double bond on the ring may be a single bond; M¹ represents a boron atom or an aluminum atom; Z¹⁺ represents an inorganic or organic cation; X¹ and X² each independently represents a carbon atom or a nitrogen atom; and when X¹ and X² represent a nitrogen atom, R⁵ and R⁶ are not present.
